(19) United States
(12) Patent Application Publication
(10) Pub. No.: US 2023/0394980 A1
(43) Pub. Date: Dec. 7, 2023

(54) Unmanned Aerial Vehicle (UAV), Device, Second Device and Methods Performed Thereby for Handling Identification of at Least One Aspect of the UAV

(71) Applicant: TELEFONAKTIEBOLAGET LM ERICSSON (publ), Stockholm (SE)

(72) Inventors: Antonino Orsino, Kirkkonummi (FI); Helka-Liina Määttänen, Espoo (FI); Mattias Bergström, Sollentuna (SE)

(21) Appl. No.: 18/250,813

(22) PCT Filed: Dec. 6, 2021
(86) PCT No.: PCT/SE2021/051205

§ 371 Date: Apr. 27, 2023

Related U.S. Application Data
(60) Provisional application No. 63/122,019, filed on Dec. 7, 2020.

(51) Int. Cl. G08G 5/00

(52) U.S. Cl. CPC G08G 5/0052; G08G 5/0013; G08G 5/0069; G08G 5/0082

(57) ABSTRACT

A method, performed by an Unmanned Aerial Vehicle, UAV, (111) operating in a wireless communications network (100). The UAV 111 determines (501) that one or more criteria have been met. The UAV 111 then provides (504) a first indication. The first indication enables identification of at least one aspect of the UAV (111). The providing (504) is triggered by a result of the determining (501). The providing (504) is performed with the proviso that the one or more criteria are met.

### TECHNICAL FIELD

The present disclosure relates generally to an unmanned aerial device (UAV) and methods performed thereby for handling identification of at least one aspect of the UAV. The present disclosure further relates generally to a device, and methods performed thereby for handling identification of at least one aspect of the UAV. The present disclosure further relates generally to a second device, and methods performed thereby for handling identification of at least one aspect of the UAV.

### BACKGROUND

Wireless devices within a wireless communications network may be e.g., User Equipments (UE), wireless devices, stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNodeB (gNB), evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called New Radio (NR) or 5G-UTRA, as well as a Fifth Generation (5G) Packet Core Network, which may be referred to as Next Generation (NG) Core Network, abbreviated as NG-CN, NGC or 5G CN.

Regulatory Aspects

Drone UE identification may be understood to be important in order to provide the right service optimization for drone UEs, to protect ground devices and for safety, security, regulatory, and law enforcement. In some regions, e.g., Japan, permission may be needed in order to be connected to an LTE network while airborne.

The drone identification is also heavily discussed in the USA. Law Enforcement, the Department of Homeland Security and the Department of Justice, blocked progress on relaxing Unmanned Aerial Vehicle (UAV), rules until the Federal Aviation Administration (FAA), came up with a solution for how to identify drones. In addition, states and local governments have passed drone related ordinances covering issues such as invasion of privacy, nuisance behavior, damage of property, etc. Two identification methods may be expected based on the class of drone. The first method may be via Broadcast identifier or identity (ID). According to this method, the drone may transmit its identification and owner information. The second method may be via Network Tracking. According to this method, location information may be transmitted back to an Unmanned Aerial Service (UAS), service supplier. Information on the drone may be obtained by querying the service supplier. Based on the class and usage of the drone, one or both methods may be required. Currently, it is not expected that hobbyist drones will require remote ID functionality. Technologies used on larger aircraft are in general inadequate or too expensive for the small UAV market. The Federal Aviation Administration (FAA) has not yet selected a technical solution. The FAA has issued a Request for Information (RFI) collecting further information.

The Federal Communications Commission (FCC) Technical Advisory Committee is reviewing technologies but has only completed the evaluation for one technology. 3GPP technologies were found suitable for use in low altitude drones.

Current LTE/NR Support

The Release-15 work item on enhanced LTE support for aerial vehicles is based on the preceding study item whose outcome was documented in 3GPP TR 36.777, version 15.0.0. The work item aimed to specify features that may improve the efficiency and robustness of terrestrial LTE network for providing aerial connectivity services, particularly for low altitude unmanned aerial vehicles a.k.a., drones.

For supporting the regulatory requirements for drone UE identification in LTE networks, Rel-15 specified a subscription-based authorization method. Support of Aerial UE function may be stored in the user's subscription information in the Home Subscriber Server (HSS). The HSS may transfer this information to the Mobility Management Entity (MME), from where it may be provided to the eNB via the S1 AP. In addition, for X2-based handover, the source eNB may include the subscription information in the X2-AP Handover Request message to the target eNB. For the intra and inter MME S1 based handover, the MME may provide the subscription information to the target eNB after the handover procedure. The eNB may then combine this information with radio capability indication from the aerial UE in order to identify whether the aerial UE has been authorized to be connected to E-UTRAN network while flying.

Rel-15 did not discuss drone ID.

Existing Plans in 3GPP

In order to have at least similar support for NR for UAVs as there is for LTE, a Work Item (WI) has been proposed in Rel-16 and Rel-17, e.g., in RP-192158 Enhanced NR Support for Aerial Vehicles. However, due to downscoping, even though there has been wide support for the UAV work, it has been left out. The proposals in the objective are a copy of Rel-15 LTE scope, namely, the objective is to specify the following improvements or enhanced NR support for aerial vehicles. A first objective of specification is aerial UE-specific reporting, such as height, location and flight path reporting [RAN2]. A second objective of specification is subscription-based identification [RAN2/RAN3/SA2]. Particularly, to specify NG/Xn signalling to support subscription-based aerial UE identification. A third objective of specification is Small Radio Resource Management (RRM) or mobility enhancements to for instance control the amount of measurement reports [RAN2].

NR V2X

Cellular Intelligent Transport Systems (C-ITS) aims at defining a new cellular eco-system for the delivery of vehicular services and their dissemination. Such eco-system may include both short range and long range Vehicle-to-everything (V2X) service transmissions, as depicted in FIG. 2. In particular, short range communication may involve transmissions over the Device-to-Device (D2D) link, also defined as sidelink or PC5 interface in 3GPP, towards other vehicular UEs or road side units (RSU). On the other hand, for long range transmission, it may consider the transmission over the Uu interface between a UE and a base station, in which case packets may be disseminated to different ITS service providers, which may be road traffic authorities, road operators, automotive Original Equipment Manufacturers (OEMs), cellular operators, etc.

When it comes to the sidelink interface, the first standardization effort in 3GPP dates back to Rel. 12, targeting public safety use cases. Since then, a number of enhancements have been introduced with the objective to enlarge the use cases that may benefit of the D2D technology. Particularly, in LTE Rel-14 and Rel-15, the extensions for the D2D work consist of supporting V2X communication, including any combination of direct communication between vehicles (V2V), pedestrians (V2P) and infrastructure (V2I).

In RAN #80, a new Study Item named “Study on NR V2X” was approved to study the enhancement to support advanced V2X services beyond services supported in LTE Rel-15 V2X. One of the objectives for NR V2X design is to study technical solutions for Quality of Service (QoS) management of the radio interface including both Uu, that is, network-to-vehicle UE communication, and sidelink, that is, vehicle UE-to-vehicle UE communication, that may be used for V2X operations.

While LTE V2X may be understood to mainly aim at traffic safety services, NR V2X may be understood to have a much broader scope including not only basic safety services, but also targeting non-safety applications, such as extended sensor and/or data sharing between vehicles, with the objective to strengthen the perception of the surrounding environment of vehicles. Hence, a new set of applications have been captured in TR 22.886 v16.2.0, such as advanced driving, vehicles platooning, cooperative manoeuvre between vehicles and remote driving that may require an enhanced NR system and a new NR sidelink framework.

In this new context, the expected requirements to meet the needed data rate, capacity, reliability, latency, communication range and speed are made more stringent. What is more, both communication interfaces, PC5 and Uu, may be used to support the advanced V2X use cases, taking into account radio conditions and the environment where the enhanced V2X (eV2X) scenario may take place. For example, given the variety of services that may be transmitted over the sidelink, a robust QoS framework which may take into account the different performance requirements of the different V2X services may be needed. Additionally, new radio protocols to handle more robust and reliable communication may need to be designed. All of these issues are currently under the investigation of 3GPP in NR Rel. 16.

NR Sidelink Flow and Radio Bearer Configuration Provision

In NR, a sidelink (SL) QoS flow model may be adopted. At the Non Access Stratum (NAS) layer, a UE may map one V2X packet into the corresponding SL QoS flow and then map to a SL radio bearer at the Service Data Adaptation Protocol (SDAP) layer.

In NR, an SL radio bearer (SLRB) configuration, including the QoS flow to Sidelink Radio Bearer (SLRB) mapping, may be either preconfigured or configured by the network (NW) when the UE may be in coverage. For instance, as shown in FIG. 3, when a UE may want to establish a new SL QoS flow and/or SLRB for a new service, it may send a request to the associated gNB. The request may include the QoS information of the service. The gNB may then determine an appropriate SLRB configuration to support such a SL QoS flow. After receiving the SLRB configuration from the gNB, the UE may establish the local SLRB accordingly and prepare for data transmission over the SL. Note that to enable successful reception at the receiver (RX) UE side, the transmitter (TX) UE may have to inform the RX UE regarding necessary parameters, e.g., sequence number space for Packet Data Convergence Protocol and/or Radio Link Control (PDCP and/or RLC), before the data transmission may start.

UE RRC States

Radio Resource Control (RRC) operation may depend on the UE specific states. A UE may be in either RRC_CONNECTED state, RRC_INACTIVE state or RRC_IDLE state. The different RRC states may have different amounts of radio resources associated with them and that the UE may use in a given specific state. In RRC_INACTIVE and RRC_IDLE state, UE controlled mobility based on Network (NW) configuration may be adopted, that is, the UE may acquire System Information Block (SIB), perform neighboring cell measurements and cell (re-)selection, and monitor a Paging occasion. An inactive UE may store the UE Inactive Access Stratum (AS) context and perform RAN-based Notification Area (RNA) updates.

In RRC_CONNECTED state however, NW controlled mobility may be performed. In fact, the Radio Access Network (RAN) node may receive paging assistance information related to potential paging triggers, such as QoS flows or signaling, from the 5G CN. The UE may thus be known by the NW at node and/or cell level and a UE specific bearer may be established, upon which UE specific data and/or control signaling may be communicated. For example, the RAN may configure UE-specific RNAs that may make it possible to reduce the total signaling load by configuring small RNAs for stationary UEs, optimized for low paging load, and, especially, larger RNAs for moving UEs, optimized for vehicular UEs.

Furthermore, if, e.g., there is no traffic transmission and/or reception for a certain timer period, the network may initiate the RRC connection release procedure to transit a UE in RRC_CONNECTED to RRC_IDLE; or to RRC_INACTIVE if SRB2 and at least one Data Radio Bearer (DRB) may be setup in RRC_CONNECTED.

Sidelink resource allocation There may be two different resource allocation (RA) procedures for V2X on sidelink, that is, NW controlled RA, so called “mode 3” in LTE and “mode 1” in NR, and autonomous RA, so called “mode 4” in LTE and “mode 2” in NR. The transmission resources may be selected within a resource pool which may be predefined or configured by the network (NW).

With NW controlled RA, the Next Generation Radio Access Network (NG-RAN) may be in charge of scheduling SL resource(s) to be used by a UE for SL transmission(s). The UE may send a SL Buffer Status Report (BSR) to the NW to inform about SL data available for transmission in the SL buffers associated with the UE's Media Access Control (MAC) entity. The NW may signal then the resource allocation to the UE using Downlink Control Information (DCI). NW controlled, or Mode-1, resource allocation may be realized via dynamic scheduling signalling via Physical Downlink Control Channel (PDCCH), or by semi-persistent scheduling, in which the gNB may provide one or more configured SL grants. Both type-1 and type-2 configured SL grants may be supported.

With autonomous RA, each device may independently decide which SL radio resources to use for SL operations, based on, e.g., sensing. For both RA modes, a sidelink control information (SCI) may be transmitted on a Physical Sidelink Control Common Channel (PSCCH) to indicate the assigned sidelink resources for the Physical Sidelink Shared Channel (PSSCH). Unlike NW controlled RA, which may only be performed when a UE is in RRC_CONNECTED state, autonomous RA, or Mode-2, may be performed both when the UE is in RRC_CONNECTED mode and when the UE is in INACTIVE or IDLE state, and also when the UE is under Uu coverage and out-of-coverage. In particular, when the UE is in RRC_CONNECTED mode, the SL resource pool may be configured with dedicated RRC signalling, while for IDLE or INACTIVE mode operations, the UE may need to rely on the SL resource pool provisioned in a broadcasting signal, e.g., SIB.

Currently, as part of the NR-V2X Study Item, 3GPP is investigating a possible extension of such mode-2. For example, 3GPP is considering the possibility to introduce a new UE functionality, in which a UE under certain conditions, e.g., for groupcast SL communication, may be allowed to provision other UEs with a mode-2 pool to be used for SL communication, e.g. for SL communication within a group of UEs, such as a platoon of vehicles.

Configured grant may be supported for NR sidelink, for both type 1 and type 2. With configured grant, the gNB may allocate sidelink resources for multiple, e.g., periodical, transmissions to the UE. Type 1 configured grant may be configured and activated directly via dedicated RRC signaling, type 2 configured grant may be configured via dedicated RRC signaling, but only activated and/or released via DCI transmitted on PDCCH.

In spite of the available technology, Drone UE identification according to existing methods may be unreliable and subject to interference.

### SUMMARY

As part of the development of embodiments herein, one or more challenges with the existing technology will first be identified and discussed.

The current American Society for Testing and Materials (ASTM) standard allows only WiFi, Bluetooth 4 (BT4), or Bluetooth 5 (BT5) to be used for broadcast of a Drone (ID). The reason WiFi and Bluetooth were selected was because there was a requirement that the technology needed to be in current devices, or at least coming soon. However, the current options of WiFi and Bluetooth are unlicensed and hence very susceptible to interference, especially in crowded urban environments.

Furthermore, currently, the Sidelink framework specified for LTE and/or NR does not allow the drone ID to be send and/or shared with the proximity devices and/or nodes via the PC5 interface. Therefore, the details on how to support drone ID via the PC5 interface have not been captured yet and this is currently not supported.

It is an object of embodiments herein to improve the handling of identification of at least one aspect of a UAV.

According to a first aspect of embodiments herein, the object is achieved by a method, performed by an Unmanned Aerial Vehicle (UAV). The method is for handling identification of at least one aspect of the UAV. The UAV operates in a wireless communications network. The UAV determines that one or more criteria have been met. The UAV also provides a first indication. The first indication enables identification of at least one aspect of the UAV. The providing is triggered by a result of the determining. The providing is performed with the proviso that the one or more criteria are met.

According to a second aspect of embodiments herein, the object is achieved by a method, performed by a device. The method is for handling identification of at least one aspect of the UAV. The device operates in the wireless communications network. The device receives, from the UAV the first indication enabling identification of at least one aspect of the UAV. The receiving is performed with the proviso that the one or more criteria are met.

According to a third aspect of embodiments herein, the object is achieved by a method, performed by a second device. The method is for handling identification of at least one aspect of the UAV. The second device operates in the wireless communications network. The second device sends a request to the UAV to provide the first indication enabling identification of at least one aspect of the UAV.

According to a fourth aspect of embodiments herein, the object is achieved by the UAV, for handling identification of at least one aspect of the UAV. The UAV is configured to operate in the wireless communications network. The wireless device is further configured to determine that the one or more criteria have been met. The wireless device is further configured to provide the first indication configured to enable the identification of at least one aspect of the UAV. The providing is configured to be triggered by the result of the determining. The providing is configured to be performed with the proviso that the one or more criteria are met.

According to a fifth aspect of embodiments herein, the object is achieved by the device, for handling identification of at least one aspect of the UAV. The device is configured to operate in the wireless communications network. The device is further configured to receive, from the UAV, the first indication configured to enable the identification of at least one aspect of the UAV. The receiving is configured to be performed with the proviso that the one or more criteria are met.

According to a sixth aspect of embodiments herein, the object is achieved by the second device, for handling identification of at least one aspect of the UAV. The second device is configured to operate in the wireless communications network. The second device is further configured to send the request to the UAV to provide the first indication configured to enable identification of at least one aspect of the UAV.

By determining that the one or more criteria have been met and providing the first indication enabling identification of at least one aspect of the UAV with the proviso that the one or more criteria have been met, the UAV may be enabled to then only provide the first indication when it may be necessary, and e.g., refrain from providing the first indication otherwise. This may be understood to enable the UAV, and any receiving devices just as the device, to only use the resources that may be needed for the transmission of the first indication when it may be necessary, and not otherwise. Hence, communications may be performed more efficiently in the wireless communications system, reducing the interference and the overhead.

By the second device sending the request, the UAV may be enabled to only provide the first indication when requested by the second device, and e.g., refrain from providing the first indication otherwise. Hence, communications may be performed more efficiently in the wireless communications system, reducing the interference and the overhead.

### BRIEF DESCRIPTION OF THE DRAWINGS

Examples of embodiments herein are described in more detail with reference to the accompanying drawings, according to the following description.

FIG. 1 is a schematic diagram depicting a non-limiting example of Four Tiered ID Spaces.

FIG. 2 is a schematic diagram depicting a non-limiting example of a C-ITS environment.

FIG. 3 is a schematic diagram depicting a non-limiting example of an NR SL radio bearer configuration provided from NW.

FIG. 4 is a schematic diagram depicting an example of a wireless communications network, according to embodiments herein.

FIG. 5 is a flowchart depicting a method in an Unmanned Aerial Vehicle, according to embodiments herein.

FIG. 6 is a flowchart depicting a method in a device, according to embodiments herein.

FIG. 7 is a flowchart depicting a method in a second device, according to embodiments herein.

FIG. 8 is a flowchart depicting a method in an Unmanned Aerial Vehicle, related to embodiments herein.

FIG. 9 is a schematic block diagram illustrating two embodiments, in panel a) and panel b), of a UAV, according to embodiments herein.

FIG. 10 is a schematic block diagram illustrating two embodiments, in panel a) and panel b), of a device, according to embodiments herein.

FIG. 11 is a schematic block diagram illustrating two embodiments, in panel a) and panel b), of a second device, according to embodiments herein.

FIG. 12 is a schematic block diagram illustrating a telecommunication network connected via an intermediate network to a host computer, according to embodiments herein.

FIG. 13 is a generalized block diagram of a host computer communicating via a base station with a user equipment over a partially wireless connection, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

FIG. 16 is a flowchart depicting embodiments of a method in a communications system including a host computer, a base station and a user equipment, according to embodiments herein.

FIG. 17 is a flowchart depicting embodiments of a method in a communications system including a host computer, a base station and a user equipment, according to embodiments herein.

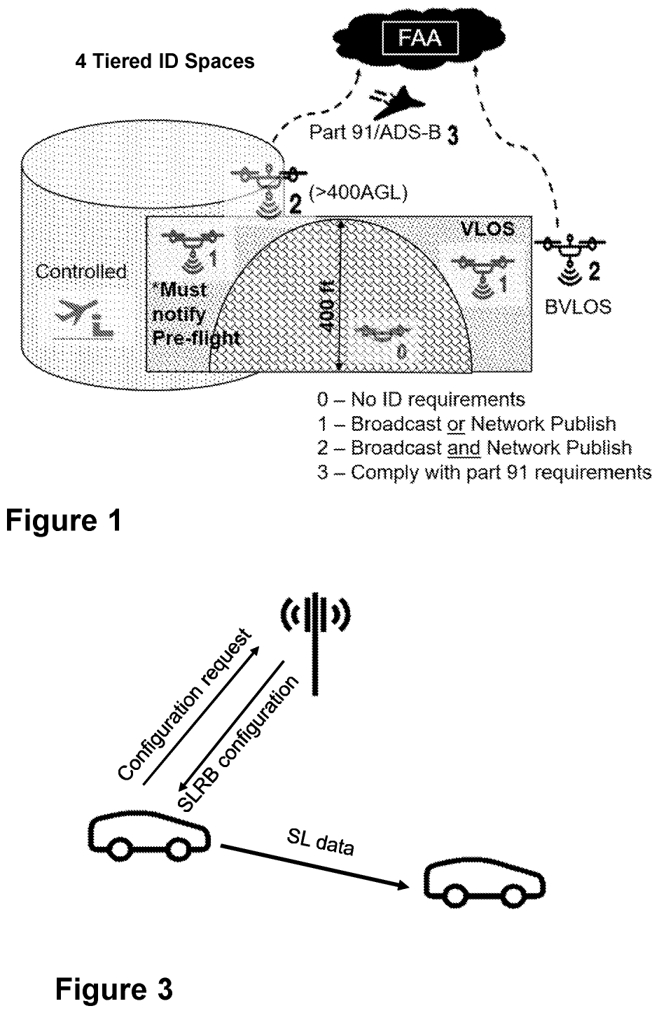

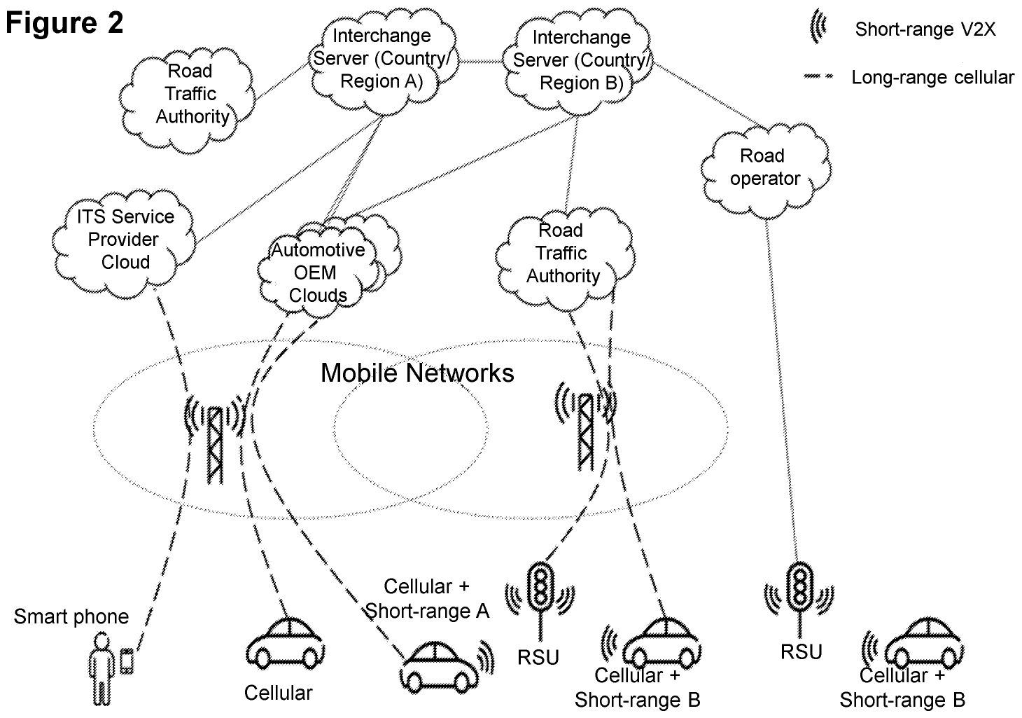

### DETAILED DESCRIPTION

Certain aspects of the present disclosure and their embodiments may provide solutions to these or other challenges.

Embodiments herein may be generally understood to relate to sending a drone ID via a PC5 connection. Embodiments herein may be understood to allow a drone ID to be sent, e.g., broadcasted to devices in proximity or via network nodes that may not be aware of this parameter. In particular, according to embodiments herein, the drone may broadcast its ID to a device in proximity based on one of the following criteria. One criterion may be geographical position. The drone may start to send, e.g., broadcast its ID once a certain position or location may be reached by the drone. Another criterion may be periodically. The drone may start to send, e.g., broadcast its ID periodically according to a time frequency. A further criterion may be event triggered. The drone may start to send, e.g., broadcast the ID when a certain event may happen, e.g., low battery or low signaling strength towards the network or when a height threshold may be crossed. Further, the drone ID may be requested on-demand by authorities, via a UE or gNB, that may want to know drone information or whether the drone may be authorized to fly in a certain area and/or conditions.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

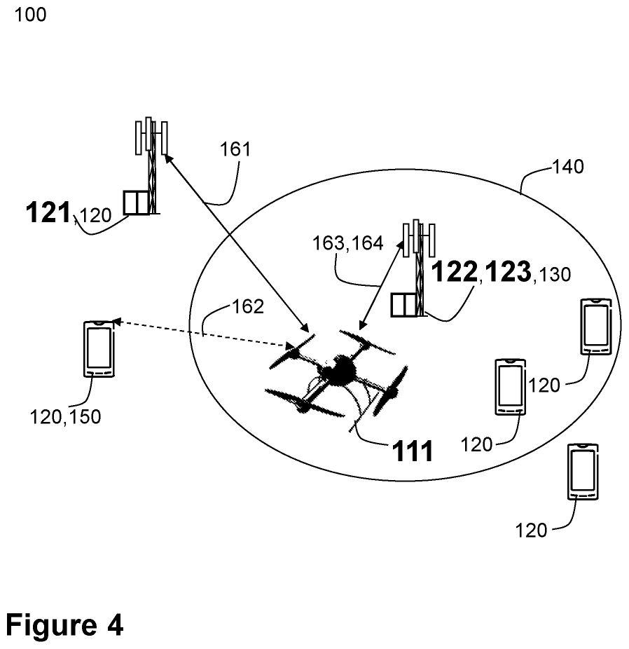

FIG. 4 depicts a non-limiting example of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE LAA, eLAA, feLAA and/or MulteFire. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g., Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may be support Machine Type Communication (MTC), enhanced Machine Type Communication (eMTC), Internet of Things (IoT) and/or NarrowBand IoT (NB-IoT). Thus, although terminology from 5G/NR and LTE may be used in this disclosure to exemplify embodiments herein, this should not be seen as limiting the scope of the embodiments herein to only the aforementioned system.

The wireless communications network 100 comprises an Unmanned Aerial Vehicle (UAV) 111 or drone. Further, in the following, the terms drone, UAVs and unmanned vehicles may be exchanged without any loss of meaning.

Also, the term “device” may identify a UE device, a network node (eNB, gNB) or any other equipment capable of transmitting or receiving over the RAT on which transmission and reception may be performed. It may sometimes herein be said that a drone, e.g., the UAV 111, sends something to another device, e.g., network or UE, or another drone, etc. and it may be understood that this may for example be done by a UE which may be attached/associated with the drone, e.g., the UAV 111.

The wireless communications network 100 may comprise one or more devices 120, which may be also referred to as one or more nodes 120, or one or more receiving devices 120. The one or more devices 120 may comprise at least one device 120 or node 120. The one or more devices 120 may be understood as, e.g., receiving devices of communications from the UAV 111. Any of the one or more devices 120 may be a network node, as the network node 130 described below, or a wireless device, such as the wireless device 150 described below.

The wireless communications network 100 may comprise a first device 121, which may be also referred to as a first node 121. The first device 121 may be a network node, such as the network node 130 described below, or a wireless device, such as the wireless device 150 described below. The first device 121 may be one of the one or more devices 120, or it may be different from any of the one or more devices 120.

The wireless communications network 100 may comprise a second device 122, which may be also referred to as a second node 122 or requesting device 122. The second device 122 may be a network node, such as the network node 130 described below, or a wireless device, such as the wireless device 150 described below. The second device 122 may be one of the one or more devices 120, or it may be different from any of the one or more devices 120.

The wireless communications network 100 may comprise a third device 123, which may be also referred to as a third node 123. The third device 123 may be understood to be a network node, such as the network node 130 described below. The third device 123 may be one of the one or more devices 120, or it may be different from any of the one or more devices 120.

In some examples, at least two of the first device 121, the second device 122, and the third device 123 may be the same device. In other examples, the first device 121, the second device 122, and the third device 123 may be different devices. Particularly, the second device 122 may, in some examples, be the same device as the third device 123, as depicted in the non-limiting example of FIG. 4, or a different device.

The wireless communications network 100 may comprise a plurality of network nodes, whereof a network node 130 is depicted in the non-limiting example of FIG. 4. The network node 130 is a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, which are not depicted in FIG. 4, the network node 130 may be a distributed node, and may partially perform its functions in collaboration with a virtual node in the cloud.

The wireless communications network 100 may cover a geographical area, which in some embodiments may be divided into cell areas, wherein each cell area may be served by a radio network node, although, one radio network node may serve one or several cells. In the example of FIG. 4, the network node 130 serves a cell 140. The network node 130 may be of different classes, such as, e.g., macro eNodeB, home eNodeB or pico base station, based on transmission power and thereby also cell size. In some examples, the network node 130 may serve receiving nodes with serving beams. The radio network node may support one or several communication technologies, and its name may depend on the technology and terminology used. Any of the radio network nodes that may be comprised in the communications network 100 may be directly connected to one or more core networks.

A plurality of wireless devices may be located in the wireless communication network 100, whereof a wireless device 150, is depicted in the non-limiting example of FIG. 4. The wireless device 150 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as the UAV 111, a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 150 comprised in the wireless communications network 100 may be enabled to communicate wirelessly in the wireless communications network 100. The communication may be performed e.g., via a RAN, and possibly the one or more core networks, which may be comprised within the wireless communications network 100. Any of the one or more devices 120 depicted in FIG. 4 with the same icon as the wireless device 150 may be understood to be a wireless device.

Any of the one or more devices 120 may be configured to communicate within the wireless communications network 100 with the UAV 111 over a respective first link 161, e.g., a radio link. Only one of the respective first links 161 is represented in FIG. 4 to simplify the Figure. The first device 121 may be configured to communicate within the wireless communications network 100 with the UAV 111 over a second link 162, e.g., a radio link. The second device 122 may be configured to communicate within the wireless communications network 100 with the UAV 111 over a third link 163, e.g., a radio link or a wired link. The third device 123 may be configured to communicate within the wireless communications network 100 with the UAV 111 over a fourth link 164, e.g., a radio link.

In the non-limiting example of FIG. 4, the first device 121 is a first network node. The second device 122 is the same as the third device 123, and is another network node. The first device 121 is comprised in the one or more devices 120. However, it may be understood that this is for illustrative purposes only, and that other combinations are also possible, as may be understood by the skilled person. It may also be understood that the wireless communications network 100 may comprise further devices than those represented in FIG. 4.

The methods described herein may be applied for the NR radio access technology (RAT) but may be applied without any loss of meaning to LTE RAN and any technology that may enable direct communication between nearby devices.

Embodiments herein are described within the context of LTE, that is, E-UTRAN or NR. It may be understood that the problems and solutions described herein may be equally applicable to wireless access networks and user equipments (UEs) implementing other access technologies and standards. LTE/NR may be used as an example technology where embodiments herein may be suitable, and using LTE/NR in the description therefore may be particularly useful for understanding the problem and solutions solving the problem.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third” and/or “fourth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a UAV, such as the UAV 111, embodiments related to a device, such as any of the one or more devices 120, e.g., a 5G UE or a UE, or a gNB or eNB, and embodiments related to second device, such as the second device 122, e.g., a network node, such as the network node 130, e.g., a gNB or an eNB.

Some embodiments herein will now be further described with some non-limiting examples.

In the following description, any reference to a/the drone, or UAV may be understood to equally refer the UAV 111; any reference to a/the gNB, a/the eNB and/or a/the network may be understood to equally refer to the network node 150.

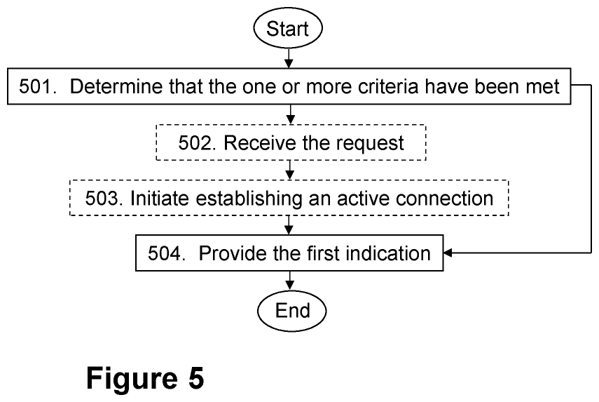

Embodiments of a method, performed by the UAV 111, will now be described with reference to the flowchart depicted in FIG. 5. The method may be understood to be for handling identification of at least one aspect of the UAV 111. The UAV 111 operates in the wireless communications network 100.

The method may be understood to be a computer-implemented method.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the UAV 111 is depicted in FIG. 5. In FIG. 5, optional actions in some embodiments may be represented with dashed lines.

Action 501

In this Action 501, the UAV 111 determines that one or more criteria have been met.

Determining in this Action 501 may comprise detecting, deciding or calculating.

The one or more criteria may comprise one or more of: a) a geographical location of the UAV 111, b) a time periodicity, c) an occurrence of an event, and d) a request to provide the first indication received from the second device 122.

By determining that the one or more criteria have been met in this Action 501, the UAV 111 may be enabled to only then provide, as will be described in Action 504, a first indication enabling identification of at least one aspect of the UAV 111, with the proviso that the one or more criteria have been met, and e.g., refrain from providing the first indication otherwise. This may be understood to enable the UAV 111 and the device 120 to only use any resources that may be needed for the transmission of the first indication may be necessary, and not otherwise. Hence, communications may be performed more efficiently in the wireless communications system 100, reducing the interference and the overhead.

Action 502

In another group of examples, the second device 122, e.g., a UE or a gNB may decide to trigger a request to acquire information from the UAV 111, which may be a drone in proximity, if the wireless device 150, e.g., UE, triggers the procedure, or under the coverage, if the network node 130, e.g., a gNB, triggers the procedure.

In this Action 502, the UAV 111 receive the request from the second device 122.

The receiving in this Action 502 may be performed, e.g., via the third link 163.

By receiving the request in this Action 502, the UAV 111 may be enabled to determine whether at least this criterion may have been met. This may enable that the UAV 111 may provide, as will be described in Action 504, the first indication enabling identification of at least one aspect of the UAV 111, with the proviso that such provision may have been requested. The advantages described in the previous action may therefore be achieved.

It may be understood that Action 501 may be performed, e.g., periodically, and/or that Action 502 may be performed before or at the same time, or as a part of Action 501.

If the second device 122 is a network node 130 such as a gNB and it wants to acquire information from the UAV 111, this may be done in two different ways. In a first approach, if the UAV 111 is already connected to the network node 130, in RRC_CONNECTED, the network node 130, e.g., gNB, may send an RRC message to the UAV 111 for requesting information. It may be a particular information or a general request. In a second approach, if the UAV 111 is in RRC_IDLE/INACTIVE, since the network node 130, e.g., gNB, does not have a direct RRC connection with the drone, the network node 130, e.g., gNB may request the reporting of drone information by broadcasting this request in system information block. This may indeed advertise that all the drones under the coverage of the network node 130, e.g., gNB, may need to initiate the reporting procedure.

Action 503

If the second device 122, e.g., UE, triggers the request to acquire drone information, a PC5 connection may be established, if not present yet, between the UAV 111 and the second device 122, e.g., UE, or with the third device 123. In typical examples, the second device 122 may be the same as the third device 123. However, in other examples, e.g., wherein the UAV 111 may have moved after receiving the request from the second device 122, or wherein the UAV 111 may be under the coverage of a different cell, e.g., under the control of a secondary node or a primary node, the third device 123 may be different than the second device 122.

In this Action 503, the UAV 111 may initiate establishing an active connection with the third device 123, that is, the second device 122 or another device.

The initiating establishing in this Action 503 may be triggering, enabling or sending, e.g., transmitting one or more messages to establish the active connection, and may be performed, e.g., via the fourth link 164.

If the wireless device 150, e.g., UE, triggers the request to acquire drone information, a PC5 connection may be established, if not present yet, between the UAV 111 and the wireless device 150, e.g., UE.

Action 504

In this Action 504, the UAV 111 provides the first indication. The first indication enables identification of at least one aspect of the UAV 111. The providing in this Action 504 is triggered by a result of the determining in Action 501. The providing in this Action 504 may be performed with the proviso that the one or more criteria are met.

The first indication, that is, the information reported by the drone, and in the above referred to as “own information” to another device, e.g., UE or gNB, may comprise at least one of: i) an identifier of the UAV 111, e.g., a Drone ID, ii) a serial number of the UAV 111, e.g., Drone serial number, and iii) a location of the UAV 111, e.g., Drone location.

In the description herein, any reference to a/the “own information” may be understood to equally refer to the first indication enabling identification of at least one aspect of the UAV 111.

The providing in this Action 504 may be to the one or more devices 120 operating in the wireless communications network 100. In some examples, the providing in this Action 504 may be to a network node such as the network node 130, and/or to a wireless device, such as the wireless device 150.

In one group of examples, the UAV 111 may provide its own information to devices or network nodes in order to enable the UAV 111 a remote authentication mechanism. According to this, the UAV 111 may provide its own information when one or more of the following criteria may happen or may be fulfilled

According one option, Option 1, the criteria may comprise geographical position. Even if there may not yet be a common regulation on how or where a drone such as the UAV 111 may be used, nearly all the countries implement geographical restriction on where drones are not allowed to fly, e.g., airports, military bases, government buildings, and so on. According to this, the UAV 111 may start to share its own information when entering a certain location or when reaching certain geographical coordinates.

According to another option, Option 2, the criteria may comprise the time periodicity, that is the providing in this Action 504 may be periodically. The UAV 111 may be configured to share periodically its own information with devices and network nodes. The periodicity may be configured by another UE, e.g., the owner or some authority devices, by the network, e.g., via dedicated RRC signaling or via system information blocks, or hard coded in the specification.

According to yet another option, Option 3, the criteria may comprise the occurrence of the event, that is, the providing in this Action 504 may be event-triggered. A drone may share its own information when a certain (pre)configured event may happen. The UAV 111 may be e.g., when the UAV 111 may lose the connection with the UE who may be controlling it, or when the signal strength may go below a certain threshold, or when a certain height may be reached.

As said above, one or more of the above options may be applied. This may for example be implemented such that the UAV 111 may start sending the own information periodically, per Option 2, if in a certain geographical location, per Option 1. Other combinations may also be possible.

In another group of examples, as another example of the event, the UAV 111 may send the own information to a potential receiver only if the UAV 111 has not yet sent the information previously. For example, if the UAV 111 has sent the own information to a certain device, e.g., network, UE, etc., the UAV 111 may not send the own information to that device again. However, if the information has changed, e.g. at least some part of the information has changed significantly, e.g., beyond a threshold, the UAV 111 may consider that the information is new or updated and hence may need to be sent again. How much the information may need to change for it to be considered new or updated may be preconfigured or specified in a specification or indicated to the UAV 111 from another device, e.g. the receiving device. The UAV 111 may also resend the information if a certain time T has passed since it was sent last time, which may be beneficial for example in case it is assumed that a receiving entity may only store the information a certain time T.

The providing in this Action 504 may be, e.g., sending or transmitting, and may be performed, e.g., via the first link 161, the second link 162, the third link 163 and/or the fourth link 164.

The providing in this Action 504 may be performed via one or more of: broadcast transmission, groupcast transmission, and unicast transmission.

In some embodiments, the providing in this Action 504 may be performed via a sidelink, e.g., to a wireless device such as the wireless device 150.

The sidelink may be performed via a PC5 interface. For example, in another group of examples, the UAV 111 may share its own information with nearby devices by using the PC5 interface, sidelink. In this case, the procedure may be done by using sidelink unicast, broadcast, or groupcast.

In case of sidelink broadcast and groupcast, the UAV 111 may use a broadcast or groupcast PC5 connection to broadcast its own information to all, broadcast, or a restricted group, groupcast, of nearby devices.

In case of sidelink unicast, this may imply that the UAV 111 may send its own information in a 1-to-1 fashion since a single PC5 connectivity with which each one of the UEs that may need the information may need to be established. In doing this, it may be the UAV 111 itself that may start the sidelink connection establishment with a nearby device or it may be also that another UE, e.g., the owner of the UAV 111 or a different UE—public authority, may request the UAV 111 to provide its own information. The UAV 111 may determine whether the intended receiver of the information has allowed or requested the UAV 111's own information and only send the own information if allowed and or requested by the receiver. The providing in this Action 504 may therefore, in some embodiments, be triggered by the received request in Action 502.

In some embodiments, a first device 121 comprised in the one of the one or more devices 120 may be a network node 130. In some of these embodiments, the providing in this Action 504 may be performed via a Uu interface. Accordingly, in yet another group of examples, the UAV 111 may share its own information with network nodes that may be in coverage by using the Uu interface. In this case, if the UAV 111 is in RRC_CONNECTED, the information may be shared, e.g., with the network node 130, e.g., a gNB, to which the UAV 111 may be connected, by using an existing or a new RRC message. If the UAV 111 is in RRC_IDLE/INACTIVE, when the information may need to be sent to the network, the UAV 111 may perform a cell (re)selection and start the RACH procedure in order to transit to RRC_CONNECTED. Once in RRC_CONNECTED, the UAV 111 may send the information to the network node 130, e.g., the gNB. As an alternative, the UAV 111 may also include the information directly in the a message sent to the network during the random access procedure. Whether or not the UAV 111 may be allowed or requested to send the own information to the network may be indicated to the UAV 111, for example by an indication in a broadcast message such as in a system information message or in a unicast message. And the UAV 111 may only send the information if allowed and/or requested. If the UE, the requesting device, is not allowed or not requested, the UAV 111, e.g., UE in the UAV 111, may refrain from establishing a connection if the sole purpose of the connection establishment would have been to send the own information.

In some embodiments, the providing in this Action 504 may be performed a) with the initiation of the establishment of the active connection, or b) via the active connection once the active connection may have been initiated.

In some embodiments, prior to providing in this Action 504 the first indication, the UAV 111 may maintain an active connection with the second device 122. In some of such embodiments, the UAV 111 may receive the request in Action 502 from the second device 122 in a Radio Resource Control message.

In the second device 122 triggers the request to acquire drone information, a connection may be established, if not present yet, between the UAV 111 and the third device 123, that is, the second device 123 or another device. Accordingly, in some embodiments, prior to providing in this Action 504 the first indication, the UAV 111 may lack an active connection with the second device 122. In some of such embodiments, the UAV 111 may receive the request from the second device 122 in a broadcasted message.

The initiating in Action 503 may be performed in embodiments wherein, prior to providing in this Action 504 the first indication, the UAV 111 may lack an active connection with the third device 123. The third device 123 may be the second device 122 or another network node.

By, in this Action 504, providing the first indication enabling identification of at least one aspect of the UAV 111, with the proviso that the one or more criteria have been met, and e.g., refrain to provide the first indication otherwise, the UAV 111 may be enabled to only use any resources that may be needed for the transmission when providing the first indication may be necessary, and not otherwise. Hence, communications may be performed more efficiently in the wireless communications system 100, reducing interference and overhead.

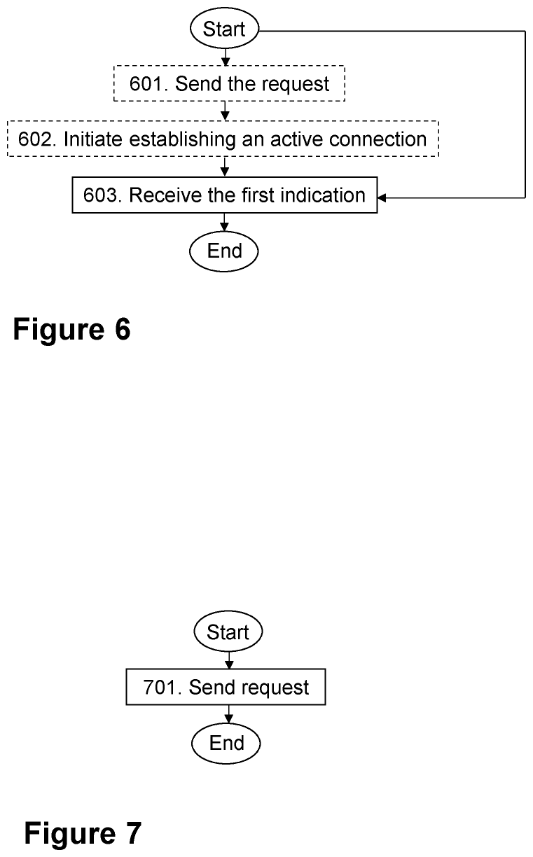

Embodiments of a method, performed by the device 120, 121, 122, 123, will now be described with reference to the flowchart depicted in FIG. 6. The method may be understood to be for handling identification of at least one aspect of the UAV 111. The device 120, 121, 122, 123 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the device 120, 121, 122, 123 is depicted in FIG. 6. In FIG. 6, optional actions in some embodiments may be represented with dashed lines.

The detailed description of some of the following corresponds to the same references provided above, in relation to the actions described for the UAV 111 and will thus not be repeated here to simplify the description. For example, the device 120 may be a wireless device, such as the wireless device 150, or a network node, such as the network node 130.

Action 601

In this Action 601, the device 120, 121, 122, 123 may send the request to the UAV 111. The request may be to provide the first indication. The first indication may enable identification of the at least one aspect of the UAV 111.

The sending in this Action 601 may comprise e.g., transmitting e.g., via the first link 161.

In some embodiments, prior to receiving the first indication later in Action 603, the device 121 may maintain an active connection with the UAV 111. In some of such embodiments, the device 121 may send the request to the UAV 111 in the RRC message.

In other embodiments, wherein, prior to receiving the first indication in Action 603, the device 121 may lack an active connection with the UAV 111, the device 121 may send the request to the UAV 111 in the broadcasted message.

Action 602

In some embodiments wherein, prior to receiving the first indication in Action 603, the device 120, 121, 122, 123 may lack an active connection with the UAV 111, and the device 121 may be the second device 122 or another network node, the device 121 may, in this Action 602, initiate establishing the active connection with the UAV 111. The device 120, 121, 122, 123 may be the second device 122 or another network node.

The initiating establishing in this Action 602 may be triggering, and/or enabling the establishment, which may comprise sending or transmitting one or more messages, and may be performed, e.g., via the fourth link 164. The first step towards the establishment of the active connection may be performed by the device 120, 121, 122, 123 or by the UAV 111.

Action 603

In this Action 603, the device 120, 121, 122, 123 receives, from the UAV 111, the first indication. The first indication may enable identification of the at least one aspect of the UAV 111. The receiving in this Action 603 may be performed with the proviso that one or more criteria are met.

The first indication may comprise at least one of: i) the identifier of the UAV 111, ii) the serial number of the UAV 111, and iii) the location of the UAV 111.

The one or more criteria may comprise one or more of: a) the geographical location of the UAV 111, b) the time periodicity, c) the occurrence of an event, and d) the request to provide the first indication from the device 121 or the second device 122.

The receiving in this Action 603 may be performed, e.g., via the first link 161, the second link 162, the third link 163 and/or the fourth link 164.

The receiving in this Action 603 may be triggered by the sent request.

In some embodiments, the receiving in this Action 603 may be performed a) with the initiation of the establishment of the active connection, or b) via the active connection once the active connection may have been initiated.

The receiving in this Action 603 may be performed via one or more of: broadcast transmission, groupcast transmission, and unicast transmission.

In some embodiments, the receiving in Action 603 may be performed via the sidelink, e.g., if the device 120, 122 is a wireless device such as the wireless device 150.

The sidelink may be performed via the PC5 interface.

In some embodiments, wherein the device may be the first device 121, wherein the first device 121 may be the network node 130, the receiving in this Action 603 may be performed via the Uu interface.

Embodiments of a method, performed by the second device 122, will now be described with reference to the flowchart depicted in FIG. 7. The method may be understood to be for handling identification of at least one aspect of the UAV 111. The second device 122 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

The method may comprise the following action. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second device 122 is depicted in FIG. 7.

The detailed description of some of the following corresponds to the same references provided above, in relation to the actions described for the UAV 111 and will thus not be repeated here to simplify the description. For example, the second device 122 may be a wireless device, such as the wireless device 150, or a network node, such as the network node 130.

Action 701

In this Action 701, the second device 122 may send the request to the UAV 111. The request may be to provide the first indication. The first indication may enable identification of the at least one aspect of the UAV 111.

The sending in this Action 701 may be performed, e.g., via third link 163.

The first indication may comprise at least one of: i) the identifier of the UAV 111, ii) the serial number of the UAV 111, and iii) the location of the UAV 111.

The sending in this Action 701 may be performed with the proviso that the one or more criteria are met.

The one or more criteria may comprise one or more of: a) the geographical location of the UAV 111, b) the time periodicity, c) the occurrence of an event, and d) the request to provide the first indication from the device 121 or the second device 122.

In some embodiments, prior to receiving the first indication later in Action 703, the device 121 may maintain an active connection with the UAV 111. In some of such embodiments, the device 121 may send the request to the UAV 111 in the RRC message.

In other embodiments, wherein, prior to receiving the first indication in Action 703, the device 121 may lack an active connection with the UAV 111, the device 121 may send the request to the UAV 111 in the broadcasted message.

The sending in this Action 701 may be performed via one or more of: broadcast transmission, groupcast transmission, and unicast transmission.

In some embodiments, the sending in this Action 701 may be performed via the sidelink, e.g., if the second device 122 is a wireless device such as the wireless device 150.

The sidelink may be performed via the PC5 interface.

In some embodiments, the second device 122 may be the network node 130. In some of such embodiments, the sending in this Action 701 may be performed via the Uu interface.

In some embodiments, the second device 122 may lack an active connection with the UV 111. In some of such embodiments, the second device 122 may send the request to the UAV 111 in a broadcasted message.

In some embodiments, the second device 122 may maintain an active connection with the UAV 111. In some of such embodiments, the second device 122 may send the request to the UAV 111 in the RRC message.

By the second device 122 sending the request, the UAV 111 may be enabled to only provide the first indication when requested by the second device 122, and e.g., refrain from providing the first indication otherwise. Hence, communications may be performed more efficiently in the wireless communications system 100, reducing the interference and the overhead

As a summarized overview of the foregoing, embodiments herein may be understood to relate to, e.g., the drone ID, to be sent/broadcasted to devices in proximity or via network nodes that may not be aware of this parameter. In particular, according to embodiments herein the UAV 111 may broadcast its ID to a device in proximity based on one of the following criteria. According one option, Option 1, the criteria may comprise geographical position. The UAV 111 may start to send, e.g., broadcast its ID once a certain position or location may be reached by the UAV 111. According to another option, Option 2, the criteria may comprise the time periodicity, that is the providing in Action 504 may be periodically. The UAV 111 may start to send, e.g., broadcast its ID periodically according to a time frequency. According to yet another option, Option 3, the criteria may comprise the occurrence of the event, that is, the providing in Action 504 may be event-triggered. The UAV 111 may start to send, e.g., broadcast the ID when a certain event may happen, e.g., low battery or low signaling strength towards the network.

Further, the drone ID may be requested on-demand by the second device 122, e.g., authorities, such as a UE or a gNB, that may want to know information about the UAV 111, e.g., drone information, or whether the UAV 111 may be authorized to fly in a certain area and/or conditions.

Certain embodiments disclosed herein may provide one or more of the following technical advantage(s), which may be summarized as follows. One advantage of embodiments herein over the existing WiFi and Bluetooth methods may be understood to be that in PC5, the resources for the broadcast may be reserved. Thus, there may be no competition on the air interface resources to send the Drone ID as there may be on unlicensed spectrum.

Further, e.g., for examples wherein the wireless communications network 100 may be LTE/NR, it may be possible to combine the broadcasting with e.g., the height threshold also specified in LTE and potentially to be specified in NR.

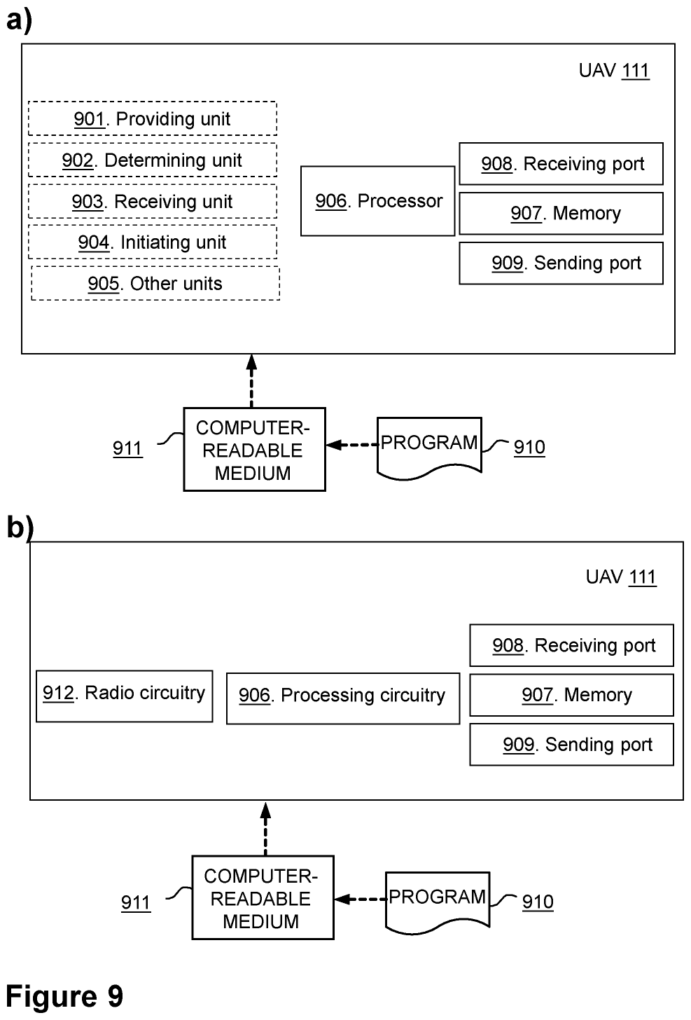

FIG. 9 depicts two different examples in panels a) and b), respectively, of the arrangement that the UAV 111 may comprise to perform the method actions described above in relation to FIG. 5. In some embodiments, the UAV 111 may comprise the following arrangement depicted in FIG. 9a.

The UAV 111 may be understood to be for handling identification of at least one aspect of the UAV 111. The UAV 111 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the UAV 111 and will thus not be repeated here. For example, in some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In FIG. 9, optional units are indicated with dashed boxes.

The UAV 111 is configured to perform the determining of Action 501, e.g. by means of a determining unit 901, configured to determine that the one or more criteria have been met.

In some embodiments, the one or more criteria may be configured to comprise one or more of: a) the geographical location of the UAV 111, b) the time periodicity, c) the occurrence of the event, and d) the request to provide the first indication configured to be received from the second device 122.

The UAV 111 is configured to perform the providing of Action 504, e.g. by means of a providing unit 902 within the UAV 111, configured to provide the first indication configured to enable identification of at least one aspect of the UAV 111. The providing is configured to be triggered by the result of the determining. The providing is configured to be performed with the proviso that the one or more criteria are met.

The first indication may be configured to comprise at least one of: i) the identifier of the UAV 111, ii) the serial number of the UAV 111, and iii) the location of the UAV 111.

In some embodiments, the providing may be configured to be to one or more devices 120 configured to operate in the wireless communications network 100.

In some embodiments, the providing may be configured to be performed via one or more of: broadcast transmission, groupcast transmission, and unicast transmission.

In some embodiments, the providing may be configured to be performed via the sidelink.

The sidelink may be configured to be performed via the PC5 interface.

In some embodiments, the first device 121 comprised in the one of the one or more devices 120 may be configured to be the network node 130 and the providing may be configured to be performed via the Uu interface.

The UAV 111 may be configured to perform the receiving of Action 502, e.g. by means of a receiving unit 903, configured to receive the request from the second device 122. The providing may be configured to be triggered by the received configured to be request.

In some embodiments, the UAV 111 may be configured to receive the request from the second device 122 in the broadcasted message with the proviso that prior to providing the first indication, the UAV may lack an active connection with the second device 122.

In some embodiments, the UAV 111 may be configured to, with the proviso that prior to providing the first indication, the UAV 111 may lack an active connection with a third device 123, and the third device 123 may be configured to be the second device 122 or another network node, perform the initiating establishing of Action 503, e.g. by means of an initiating unit 904 within the UAV 111, configured to initiate establishing an active connection with the third device 123. The providing may be configured to be performed a) with the initiation of the establishment of the active connection, or b) via the active connection once the active connection has been initiated.

In some embodiments, the UAV 111 may be configured to receive the request from the second device 122 in the RRC message with the proviso that prior to providing the first indication, the UAV 111 maintains an active connection with the second device 122.

Other units 905 may be comprised in the UAV 111.

The embodiments herein in the UAV 111 may be implemented through one or more processors, such as a processor 906 in the UAV 111 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the UAV 111. One such carrier may be in the form of a CD ROM disc. It is however feasible with other data carriers such as a memory stick. The computer program code may furthermore be provided as pure program code on a server and downloaded to the UAV 111.

The UAV 111 may further comprise a memory 907 comprising one or more memory units. The memory 907 is arranged to be used to store obtained information, store data, configurations, schedulings, and applications etc. to perform the methods herein when being executed in the UAV 111.

In some embodiments, the UAV 111 may receive information from, e.g., the one or more devices 120, 121, 122, 123, e.g., the first device 121, the second device 122, and/or the third device 123, through a receiving port 908. In some embodiments, the receiving port 908 may be, for example, connected to one or more antennas in UAV 111. In other embodiments, the UAV 111 may receive information from another structure in the wireless communications network 100 through the receiving port 908. Since the receiving port 908 may be in communication with the processor 906, the receiving port 908 may then send the received information to the processor 906. The receiving port 908 may also be configured to receive other information.

The processor 906 in the UAV 111 may be further configured to transmit or send information to e.g., one or more devices 120, 121, 122, 123, e.g., the first device 121, the second device 122, and/or the third device 123, or another structure in the wireless communications network 100, through a sending port 909, which may be in communication with the processor 906, and the memory 907.

Those skilled in the art will also appreciate that the different units 901-905 described above may refer to a combination of analog and digital modules, and/or one or more processors configured with software and/or firmware, e.g., stored in memory, that, when executed by the one or more processors such as the processor 906, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-905 described above may be implemented as one or more applications running on one or more processors such as the processor 906.

Thus, the methods according to the embodiments described herein for the UAV 111 may be respectively implemented by means of a computer program 910 product, comprising instructions, i.e., software code portions, which, when executed on at least one processor 906, cause the at least one processor 906 to carry out the actions described herein, as performed by the UAV 111. The computer program 910 product may be stored on a computer-readable storage medium 911. The computer-readable storage medium 911, having stored thereon the computer program 910, may comprise instructions which, when executed on at least one processor 906, cause the at least one processor 906 to carry out the actions described herein, as performed by the UAV 111. In some embodiments, the computer-readable storage medium 911 may be a non-transitory computer-readable storage medium, such as a CD ROM disc, or a memory stick. In other embodiments, the computer program 910 product may be stored on a carrier containing the computer program 910 just described, wherein the carrier is one of an electronic signal, optical signal, radio signal, or the computer-readable storage medium 911, as described above.

The UAV 111 may comprise a communication interface configured to facilitate communications between the UAV 111 and other nodes or devices, e.g., one or more devices 120, 121, 122, 123, e.g., the first device 121, the second device 122, and/or the third device 123. The interface may, for example, include a transceiver configured to transmit and receive radio signals over an air interface in accordance with a suitable standard.

In other embodiments, the UAV 111 may comprise the following arrangement depicted in FIG. 9b. The UAV 111 may comprise a processing circuitry 906, e.g., one or more processors such as the processor 906, in the UAV 111 and the memory 907. The UAV 111 may also comprise a radio circuitry 912, which may comprise e.g., the receiving port 908 and the sending port 909. The processing circuitry 912 may be configured to, or operable to, perform the method actions according to FIG. 5, in a similar manner as that described in relation to FIG. 9a. The radio circuitry 912 may be configured to set up and maintain at least a wireless connection with the one or more devices 120, 121, 122, 123, e.g., the first device 121, the second device 122, and/or the third device 123. Circuitry may be understood herein as a hardware component.

Hence, embodiments herein also relate to the UAV 111 comprising the processing circuitry 906 and the memory 907, said memory 907 containing instructions executable by said processing circuitry 906, whereby the UAV 111 is operative to perform the actions described herein in relation to the UAV 111, e.g., in FIG. 5.

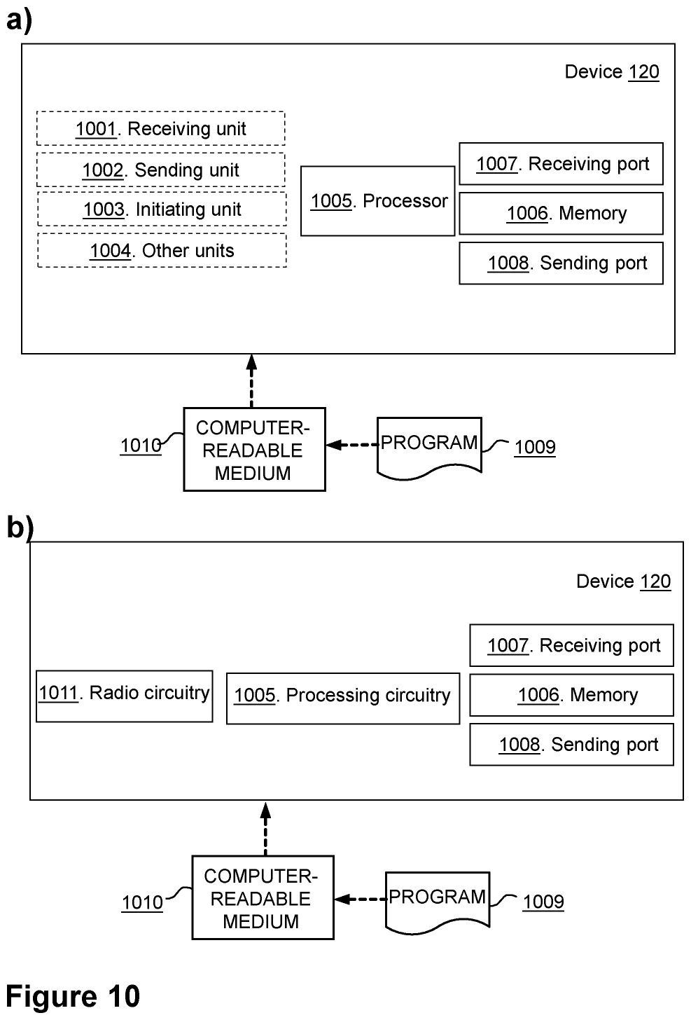

FIG. 10 depicts two different examples in panels a) and b), respectively, of the arrangement that the device 120, 121, 122, 123 may comprise to perform the method actions described above in relation to FIG. 6. In some embodiments, the device 120, 121, 122, 123 may comprise the following arrangement depicted in FIG. 10a.

The device 120, 121, 122, 123 may be understood to be for handling identification of at least one aspect of the UAV 111. The 120, 121, 122, 123 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the device 120, 121, 122, 123 and will thus not be repeated here. For example, the device 120, 121, 122, 123 may configured to be a wireless device, such as the wireless device 150, or a network node, such as the network node 130.

In FIG. 10, optional units are indicated with dashed boxes.

The device 120, 121, 122, 123 is configured to perform the receiving of Action 603, e.g. by means of a receiving unit 1001 within the device 120, 121, 122, 123, configured to receive, from the UAV 111, the first indication configured to enable identification of at least one aspect of the UAV 111. The receiving is configured to be performed with the proviso that the one or more criteria are met.

In some embodiments, the receiving may be configured to be performed via one or more of: broadcast transmission, groupcast transmission, and unicast transmission.

In some embodiments, the receiving may be configured to be performed via the sidelink.

The sidelink may be configured to be performed via the PC5 interface.

In some embodiments, the device 120, 121, 122, 123 may be configured to be the first device 121. The first device 121 may be configured to be the network node 130 and the receiving may be configured to be performed via the Uu interface.

In some embodiments, the one or more criteria may be configured to comprise one or more of: a) the geographical location of the UAV 111, b) the time periodicity, c) the occurrence of the event, and d) the request to provide the first indication from the device 121 or the second device 122.

In some embodiments, the device 121 may be configured to send the request to the UAV 111 in the broadcasted message with the proviso that prior to receiving the first indication, the device 121 may lack an active connection with the UAV 111.

The device 120, 121, 122, 123 may be configured to perform the sending of Action 601, e.g. by means of a sending unit 1002, configured to send the request to the UAV 111. The receiving may be configured to be triggered by the request configured to be sent.

In some embodiments, wherein the device 121 may be configured to be the second device 122 or another network node, and the device 120, 121, 122, 123 may be further configured to, with the proviso that prior to receiving the first indication, the device 121 lacks an active connection with the UAV 111, perform the initiating establishing of Action 602, e.g. by means of an initiating unit 1003 within the device 123 configured to initiate establishing an active connection with the UAV 111. In some of such embodiments, the receiving may be configured to be performed a) with the initiation of the establishment of the active connection, or b) via the active connection once the active connection has been initiated.

The first indication may be configured to comprise at least one of: i) the identifier of the UAV 111, ii) the serial number of the UAV 111, and iii) the location of the UAV 111.

In some embodiments, the device 121 may be configured to send the request to the UAV 111 in the RRC message, with the proviso that prior to receiving the first indication, the device 121 maintains an active connection with the UAV 111.

Other units 1004 may be comprised in the device 120, 121, 122, 123.

The embodiments herein in the device 120, 121, 122, 123 may be implemented through one or more processors, such as a processor 1005 in the device 120, 121, 122, 123 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the device 120, 121, 122, 123. One such carrier may be in the form of a CD ROM disc. It is however feasible with other data carriers such as a memory stick. The computer program code may furthermore be provided as pure program code on a server and downloaded to the device 120, 121, 122, 123.

The device 120, 121, 122, 123 may further comprise a memory 1006 comprising one or more memory units. The memory 1006 is arranged to be used to store obtained information, store data, configurations, schedulings, and applications etc. to perform the methods herein when being executed in the device 120, 121, 122, 123.

In some embodiments, the device 120, 121, 122, 123 may receive information from, e.g., the UAV 111, other devices of the one or more devices 120, the first device 121, the second device 122, and/or the third device 123, through a receiving port 1007. In some embodiments, the receiving port 1007 may be, for example, connected to one or more antennas in device 120, 121, 122, 123. In other embodiments, the device 120, 121, 122, 123 may receive information from another structure in the wireless communications network 100 through the receiving port 1007. Since the receiving port 1007 may be in communication with the processor 1005, the receiving port 1007 may then send the received information to the processor 1005. The receiving port 1007 may also be configured to receive other information.

The processor 1005 in the device 120, 121, 122, 123 may be further configured to transmit or send information to e.g., the UAV 111, other devices of the one or more devices 120, the first device 121, the second device 122, and/or the third device 123, or another structure in the wireless communications network 100, through a sending port 1008, which may be in communication with the processor 1005, and the memory 1006.

Those skilled in the art will also appreciate that the different units 1001-1004 described above may refer to a combination of analog and digital modules, and/or one or more processors configured with software and/or firmware, e.g., stored in memory, that, when executed by the one or more processors such as the processor 1005, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1004 described above may be implemented as one or more applications running on one or more processors such as the processor 1005.

Thus, the methods according to the embodiments described herein for the device 120, 121, 122, 123 may be respectively implemented by means of a computer program 1009 product, comprising instructions, i.e., software code portions, which, when executed on at least one processor 1005, cause the at least one processor 1005 to carry out the actions described herein, as performed by the device 120, 121, 122, 123. The computer program 1009 product may be stored on a computer-readable storage medium 1010. The computer-readable storage medium 1010, having stored thereon the computer program 1009, may comprise instructions which, when executed on at least one processor 1005, cause the at least one processor 1005 to carry out the actions described herein, as performed by the device 120, 121, 122, 123. In some embodiments, the computer-readable storage medium 1010 may be a non-transitory computer-readable storage medium, such as a CD ROM disc, or a memory stick. In other embodiments, the computer program 1009 product may be stored on a carrier containing the computer program 1009 just described, wherein the carrier is one of an electronic signal, optical signal, radio signal, or the computer-readable storage medium 1010, as described above.

The device 120, 121, 122, 123 may comprise a communication interface configured to facilitate communications between the device 120, 121, 122, 123 and other nodes or devices, e.g., the UAV 111, other devices of the one or more devices 120, the first device 121, the second device 122, and/or the third device 123. The interface may, for example, include a transceiver configured to transmit and receive radio signals over an air interface in accordance with a suitable standard.

In other embodiments, the device 120, 121, 122, 123 may comprise the following arrangement depicted in FIG. 10b. The device 120, 121, 122, 123 may comprise a processing circuitry 1005, e.g., one or more processors such as the processor 1005, in the device 120, 121, 122, 123 and the memory 1006. The device 120, 121, 122, 123 may also comprise a radio circuitry 1011, which may comprise e.g., the receiving port 1007 and the sending port 1008. The processing circuitry 1005 may be configured to, or operable to, perform the method actions according to FIG. 6, in a similar manner as that described in relation to FIG. 10a. The radio circuitry 1011 may be configured to set up and maintain at least a wireless connection with the UAV 111, other devices of the one or more devices 120, the first device 121, the second device 122, and/or the third device 123. Circuitry may be understood herein as a hardware component.

Hence, embodiments herein also relate to the device 120, 121, 122, 123 comprising the processing circuitry 1005 and the memory 1006, said memory 1006 containing instructions executable by said processing circuitry 1005, whereby the device 120, 121, 122, 123 is operative to perform the actions described herein in relation to the device 120, 121, 122, 123, e.g., in FIG. 6.

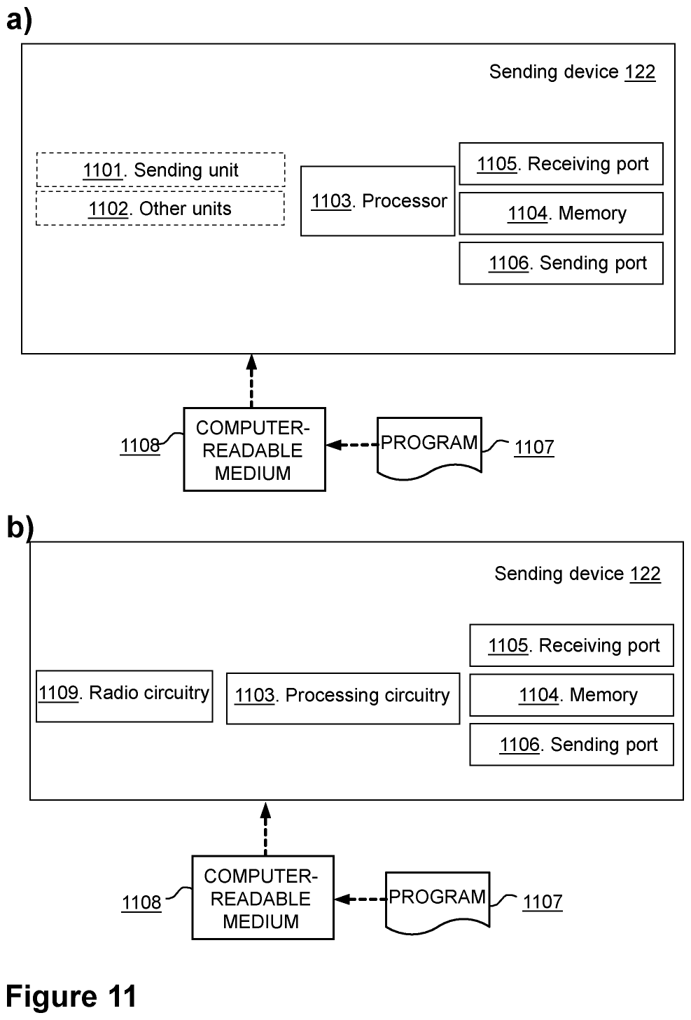

FIG. 11 depicts two different examples in panels a) and b), respectively, of the arrangement that the second device 122 may comprise to perform the method actions described above in relation to FIG. 7. In some embodiments, the second device 122 may comprise the following arrangement depicted in FIG. 11a.

The second device 122 may be understood to be for handling identification of at least one aspect of the UAV 111. The second device 122 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second device 122 and will thus not be repeated here. For example, the second device 122 may be configured to be a wireless device, such as the wireless device 150, or a network node, such as the network node 130.

In FIG. 11, optional units are indicated with dashed boxes.

The second device 122 is configured to perform the sending Action 701, e.g. by means of a sending unit 1101 within the second device 122, configured to send the request to the UAV 111 to provide the first indication configured to enable identification of at least one aspect of the UAV 111.

In some embodiments, the sending may be configured to be performed via one or more of: broadcast transmission, groupcast transmission, and unicast transmission.

In some embodiments, the sending may be configured to be performed via the sidelink.

The sidelink may be configured to be performed via the PC5 interface

In some embodiments, the second device 122 may be configured to be the network node 130, and the sending may be configured to be performed via the Uu interface.

In some embodiments, the second device 122 may be configured to send the request to the UAV 111 in the broadcasted message with the proviso the second device 122 lacks an active connection with the UAV 111.

In some embodiments, the second device 122 may be configured to send the request to the UAV 111 in the RRC message with the proviso the second device 122 maintains an active connection with the UAV 111.

The first indication may be configured to comprise at least one of: i) the identifier of the UAV 111, ii) the serial number of the UAV 111, and iii) the location of the UAV 111.

Other units 1102 may be comprised in the second device 122.

The embodiments herein in the second device 122 may be implemented through one or more processors, such as a processor 1103 in the second device 122 depicted in FIG. 11a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second device 122. One such carrier may be in the form of a CD ROM disc. It is however feasible with other data carriers such as a memory stick. The computer program code may furthermore be provided as pure program code on a server and downloaded to the second device 122.

The second device 122 may further comprise a memory 1104 comprising one or more memory units. The memory 1104 is arranged to be used to store obtained information, store data, configurations, schedulings, and applications etc. to perform the methods herein when being executed in the second device 122.

In some embodiments, the second device 122 may receive information from, e.g., the UAV 111, other devices of the one or more devices 120, the first device 121, and/or the third device 123, through a receiving port 1105. In some embodiments, the receiving port 1105 may be, for example, connected to one or more antennas in second device 122. In other embodiments, the second device 122 may receive information from another structure in the wireless communications network 100 through the receiving port 1105. Since the receiving port 1105 may be in communication with the processor 1103, the receiving port 1105 may then send the received information to the processor 1103. The receiving port 1105 may also be configured to receive other information.

The processor 1103 in the second device 122 may be further configured to transmit or send information to e.g., the UAV 111, other devices of the one or more devices 120, the first device 121, and/or the third device 123, or another structure in the wireless communications network 100, through a sending port 1106, which may be in communication with the processor 1103, and the memory 1104.

Those skilled in the art will also appreciate that the different units 1101-1102 described above may refer to a combination of analog and digital modules, and/or one or more processors configured with software and/or firmware, e.g., stored in memory, that, when executed by the one or more processors such as the processor 1103, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1101-1102 described above may be implemented as one or more applications running on one or more processors such as the processor 1103.

Thus, the methods according to the embodiments described herein for the second device 122 may be respectively implemented by means of a computer program 1107 product, comprising instructions, i.e., software code portions, which, when executed on at least one processor 1103, cause the at least one processor 1103 to carry out the actions described herein, as performed by the second device 122. The computer program 1107 product may be stored on a computer-readable storage medium 1108. The computer-readable storage medium 1108, having stored thereon the computer program 1107, may comprise instructions which, when executed on at least one processor 1103, cause the at least one processor 1103 to carry out the actions described herein, as performed by the second device 122. In some embodiments, the computer-readable storage medium 1108 may be a non-transitory computer-readable storage medium, such as a CD ROM disc, or a memory stick. In other embodiments, the computer program 1107 product may be stored on a carrier containing the computer program 1107 just described, wherein the carrier is one of an electronic signal, optical signal, radio signal, or the computer-readable storage medium 1108, as described above.

The second device 122 may comprise a communication interface configured to facilitate communications between the second device 122 and other nodes or devices, e.g., the UAV 111, other devices of the one or more devices 120, the first device 121, and/or the third device 123. The interface may, for example, include a transceiver configured to transmit and receive radio signals over an air interface in accordance with a suitable standard.

In other embodiments, the second device 122 may comprise the following arrangement depicted in FIG. 11b. The second device 122 may comprise a processing circuitry 1103, e.g., one or more processors such as the processor 1103, in the second device 122 and the memory 1104. The second device 122 may also comprise a radio circuitry 1109, which may comprise e.g., the receiving port 1105 and the sending port 1106. The processing circuitry 1103 may be configured to, or operable to, perform the method actions according to FIG. 7, in a similar manner as that described in relation to FIG. 11a. The radio circuitry 1109 may be configured to set up and maintain at least a wireless connection with the UAV 111, other devices of the one or more devices 120, the first device 121, and/or the third device 123. Circuitry may be understood herein as a hardware component.

Hence, embodiments herein also relate to the second device 122 comprising the processing circuitry 1103 and the memory 1104, said memory 1104 containing instructions executable by said processing circuitry 1103, whereby the second device 122 is operative to perform the actions described herein in relation to the second device 122, e.g., in FIG. 7.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

More specifically, the following are examples related to a UAV, such as the UAV 111, examples related to a device, such as any of the one or more devices 120, e.g., a 5G UE or a UE, or a gNB or eNB, and examples related to second device, such as the second device 122, e.g., a network node, such as the network node 130, e.g., a gNB or an eNB.

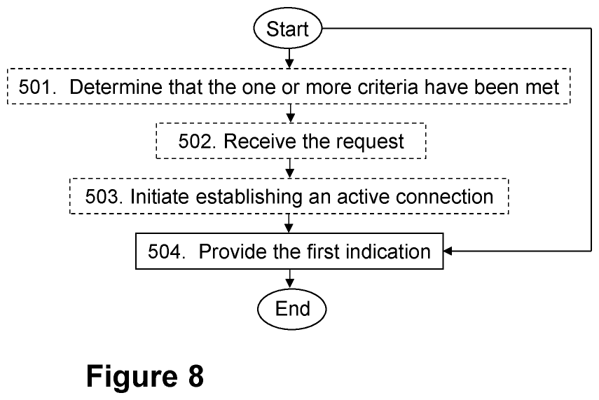

The UAV 111 examples may relate to FIG. 8, FIG. 9 and FIGS. 12-17.

A method, performed by a wireless device, such as the UAV 111 is described herein. The method may be understood to be for handling identification of a UAV, such as the UAV 111. The UAV 111 may be operating in a wireless communications network, such as the wireless communications network 100.

The first method may comprise one or more of the following actions. In some examples, all the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the UAV 111 is depicted in FIG. 8. In FIG. 8, optional actions in some examples may be represented with dashed lines.
Providing 504 a first indication. The UAV 111 may be configured to perform this providing action 504, e.g. by means of a providing unit 901 within the UAV 111, configured to perform this action.

The first indication may enable identification of at least one aspect of the UAV 111.

The providing in this Action 504 may be performed with the proviso that one or more criteria are met.

The one or more criteria may comprise one or more of:
a. a geographical location of the UAV 111,
b. a time periodicity,
c. an occurrence of an event, and
d. a request to provide the first indication received from a second device 122.

The providing 504 may be to the one or more devices 130 operating in the communications network 100.

The first indication may comprise at least one of:
i. an identifier of the UAV 111, e.g., a Drone ID, and
ii. a serial number of the UAV 111, e.g., Drone serial number, and
iii. a location of the UAV 111, e.g., Drone location.

The providing 504 may be performed via one or more of: broadcast transmission, groupcast transmission, and unicast transmission.

The providing in this Action 504 may be to a network node such as the network node 130, and/or to a wireless device, such as the wireless device 150.

The providing in this Action 504 may be, e.g., sending or transmitting, and may be performed, e.g., via the first link 161, the second link 162, the third link 163 and/or the fourth link 164.

In some examples, the providing 504 may be performed via a sidelink, e.g., to a wireless device such as the wireless device 150.

The sidelink may be performed via a PC5 interface.

In some examples, a first device 121 comprised in the one of the one or more devices 120 may be a network node 130. In some of these examples, the providing 504 may be performed via a Uu interface.

In some examples, the method may further comprise one or more of the following actions:
Determining 501 that the one or more criteria have been met. The UAV 111 may be configured to perform this determining action 501, e.g. by means of a determining unit 902, configured to perform this action.

Determining in this Action 501 may comprise detecting, deciding or calculating.

The one or more criteria may comprise one or more of the geographical location of the UAV, the time periodicity, and the occurrence of the event. The providing 504 may be triggered by a result of the determining 501.
Receiving 502 the request. The UAV 111 may be configured to perform this receiving action 502, e.g. by means of a receiving unit 903, configured to perform this action.

The receiving in this Action 502 may be performed, e.g., via the third link 163.

The receiving in this Action 502 may be from the second device 122. The providing 504 may be triggered by received request.

In some examples, prior to providing 504 the first indication, the UAV 111 may lack an active connection with the second device 122. In some of such examples, the UAV 111 may receive the request from the second device 122 in a broadcasted message.

In some examples, prior to providing 504 the first indication, the UAV 111 may maintain an active connection with the second device 122. In some of such examples, the UAV 111 may receive the request from the second device 122 in a Radio Resource Control message.
Initiating 503 establishing an active connection with the third device 123. The UAV 111 may be configured to perform this initiating establishing action 503, e.g. by means of an initiating unit 904 within the UAV 111, configured to perform this action.

The initiating establishing in this Action 503 may be triggering, enabling or sending, e.g., transmitting one or more messages to establish the active connection, and may be performed, e.g., via the fourth link 164.

In typical examples, the second device 122 may be the same as the third device 123. However, in other examples, e.g., wherein the UAV 111 may have moved after receiving the request from the second device 122, or wherein the UAV 111 may be under the coverage of a different cell, e.g., under the control of a secondary node or a primary node, the third device 123 may be different than the second device 122.

The providing 504 may be performed a) with the initiation of the establishment of the active connection, or b) via the active connection once the active connection has been initiated

The initiating in this Action 503 may be performed in examples wherein, prior to providing 504 the first indication, the UAV 111 may lack an active connection with the third device 123. The third device 123 may be the second device 122 or another network node.

In some examples, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Other units 905 may be comprised in the UAV 111.

The UAV 111 may also be configured to communicate user data with a host application unit in a host computer 1210, e.g., via another link such as 1260.

In FIG. 9, optional units are indicated with dashed boxes.

The UAV 111 may comprise an interface unit to facilitate communications between the UAV 111 and other nodes or devices, e.g., the one or more devices 120, the first device 121, the second device 122, and/or the third device 123, the host computer 1210, or any of the other nodes. In some particular examples, the interface may, for example, include a transceiver configured to transmit and receive radio signals over an air interface in accordance with a suitable standard.

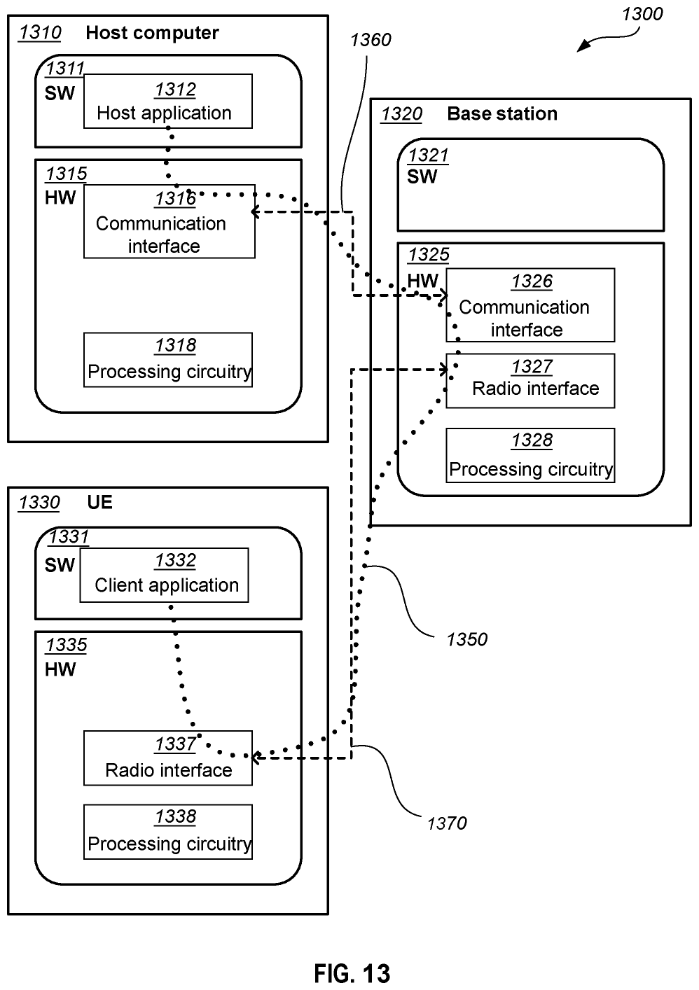

The UAV 111 may comprise an arrangement as shown in FIG. 9 or in FIG. 13.

The device 120 examples relate to FIG. 6, FIG. 10 and FIGS. 12-17.

A method, performed by a device, such as the device 120, 121, 122, 123 is described herein. The method may be understood to be for handling identification of a UAV, such as the UAV 111. The device 120, 121, 122, 123 may be operating in a wireless communications network, such as the wireless communications network 100.

The first method may comprise one or more of the following actions. In some examples, all the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the device 120, 121, 122, 123 is depicted in FIG. 8. In FIG. 8, optional actions in some examples may be represented with dashed lines.

The detailed description of some of the following corresponds to the same references provided above, in relation to the actions described for the UAV 111 and will thus not be repeated here to simplify the description. For example, the device 120 may be a wireless device, such as the wireless device 150, or a network node, such as the network node 130.
Receiving 603 the first indication. The device 120, 121, 122, 123 may be configured to perform this receiving action 603, e.g. by means of a receiving unit 1001 within the device 120, 121, 122, 123, configured to perform this action.

The receiving of the first indication in this Action 603 may be from the UAV 111.

The first indication may enable identification of at least one aspect of the UAV 111.

The receiving in this Action 603 may be performed with the proviso that the one or more criteria are met.

The one or more criteria may comprise one or more of:
a. the geographical location of the UAV 111,
b. the time periodicity,
c. the occurrence of the event, and
d. the request to provide the first indication received from the second device 122.

The first indication may comprise at least one of:
i. the identifier of the UAV 111, e.g., a Drone ID, and
ii. the serial number of the UAV 111, e.g., Drone serial number, and
iii. the location of the UAV 111, e.g., Drone location.

The receiving 603 may be performed via one or more of: broadcast transmission, groupcast transmission, and unicast transmission.

The receiving in this Action 603 may be performed, e.g., via the first link 161, the second link 162, the third link 163 and/or the fourth link 164.

In some examples, the receiving 603 may be performed via a sidelink, e.g., if the device 120, 122 is a wireless device such as the wireless device 150.

The sidelink may be performed via a PC5 interface.

In some examples, the device may be the first device 121. The first device 121 may be the network node 130. In some of such examples, the receiving 603 may be performed via a Uu interface.

In some examples, the method may further comprise one or more of the following actions:
Sending 601 the request to the UAV 111. The device 120, 121, 122, 123 may be configured to perform this sending action 601, e.g. by means of a sending unit 1002, configured to perform this action.

The receiving in Action 603 may be triggered by sent request.

The sending in this Action 601 may be from the second device 122. The sending in this Action 601 may be performed, e.g., via the third link 163.

In some examples, prior to receiving 603 the first indication, the device 122 may lack an active connection with the UV 111. In some of such examples, the device 122 may send the request to the UAV 111 in a broadcasted message.
Initiating 602 establishing an active connection with the UAV 111. The device 120, 121, 122, 123 may be configured to perform this initiating establishing action 602, e.g. by means of an initiating unit 1003 within the device 123 configured to perform this action.

The initiating establishing in this Action 602 may be triggering, and/or enabling the establishment, which may comprise sending or transmitting one or more messages, and may be performed, e.g., via the fourth link 164.

The receiving in Action 603 may be performed a) with the initiation of the establishment of the active connection, or b) via the active connection once the active connection has been initiated

The initiating in this Action 602 may be performed in examples wherein, prior to receiving 602 the first indication, the device 120, 121, 122, 123 may lack an active connection with the UAV 111. The device 120, 121, 122, 123 may be the second device 122 or another network node.

In some examples, prior to receiving 603 the first indication, the device 120, 121, 122, 123 may maintain an active connection with the UAV 111. In some of such examples, the device 122 may send the request to the UAV 111 in a Radio Resource Control message.

In some examples, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Other units 1004 may be comprised in the device 120, 121, 122, 123.

The device 120, 121, 122, 123 may also be configured to communicate user data with a host application unit in a host computer 1210, e.g., via another link such as 1260.

In FIG. 10, optional units are indicated with dashed boxes.

The device 120, 121, 122, 123 may comprise an interface unit to facilitate communications between the device 120, 121, 122, 123 and other nodes or devices, e.g., the UAV 111, other devices of the one or more devices 120, the network node 130, the host computer 1210, and/or any of the other nodes. In some particular examples, the interface may, for example, include a transceiver configured to transmit and receive radio signals over an air interface in accordance with a suitable standard.

The device 120, 121, 122, 123 may comprise an arrangement as shown in FIG. 10 or in 13.

The second device 122 examples relate to FIG. 7, FIG. 11 and FIGS. 12-17.

A method, performed by the second device 122 is described herein. The method may be understood to be for handling identification of a UAV, such as the UAV 111. The second device 122 may be operating in a wireless communications network, such as the wireless communications network 100.

The method may comprise one or more of the following actions. In some examples, all the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the second device 122 is depicted in FIG. 7. In FIG. 7, optional actions in some examples may be represented with dashed lines.

The detailed description of some of the following corresponds to the same references provided above, in relation to the actions described for the UAV 111 and will thus not be repeated here to simplify the description. For example, second device 122 may be a wireless device, such as the wireless device 150, or a network node, such as the network node 130.
Sending 701 the request. The second device 122 may be configured to perform this sending action 701, e.g. by means of a sending unit 1101 within the second device 122, configured to perform this action.

The sending of the request in this Action 701 may be to the UAV 111.

The request may be to provide the first indication.

The first indication may enable identification of the at least one aspect of the UAV 111.

The first indication may comprise at least one of:
i. the identifier of the UAV 111, e.g., a Drone ID, and
ii. the serial number of the UAV 111, e.g., Drone serial number, and
iii. the location of the UAV 111, e.g., Drone location.

The sending in this Action 701 may be performed with the proviso that the one or more criteria are met.

The one or more criteria may comprise one or more of:
a. the geographical location of the UAV,
b. the time periodicity, and
c. the occurrence of the event.

The sending in this Action 701 may be performed via one or more of: broadcast transmission, groupcast transmission, and unicast transmission.

The sending in this Action 701 may be performed, e.g., via third link 163.

In some examples, the sending in this Action 701 may be performed via a sidelink, e.g., if the second device 122 is a wireless device such as the wireless device 150.

The sidelink may be performed via a PC5 interface.

In some examples, the second device 122 may be the a network node 130. In some of such examples, the sending in this Action 701 may be performed via a Uu interface.

In some examples, the second device 122 may lack an active connection with the UV 111. In some of such examples, the second device 122 may send the request to the UAV 111 in a broadcasted message.

In some examples, the second device 122 may maintain an active connection with the UAV 111. In some of such examples, the second device 122 may send the request to the UAV 111 in a Radio Resource Control message.

In some examples, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Other units 1102 may be comprised in the second device 122.

The second device 122 may also be configured to communicate user data with the UAV 111, and/or other devices of the one or more devices 120, the network node 130, a host application unit in a host computer 1210, e.g., via another link such as 1260.

In FIG. 11, optional units are indicated with dashed boxes.

The second device 122 may comprise an interface unit to facilitate communications between the second device 122 and other nodes or devices, e.g., the UAV 111, other devices of the one or more devices 120, the network node 130, the host computer 1210, and/or any of the other nodes. In some particular examples, the interface may, for example, include a transceiver configured to transmit and receive radio signals over an air interface in accordance with a suitable standard.

The second device 122 may comprise an arrangement as shown in FIG. 11 or in 13. Selected examples related to embodiments herein

Example 1. A method, performed by an Unmanned Aerial Vehicle, UAV, (111) operating in a wireless communications network (100), the method comprising:
providing (504) a first indication enabling identification of at least one aspect of the UAV (111), wherein the providing (504) is performed with the proviso that one or more criteria are met.
   Example 2. The method according to example 1, wherein the providing (504) is to one or more devices (120) operating in the communications network (100).
   Example 3. The method according to any of examples 1-2, wherein the providing (504) is performed via one or more of: broadcast transmission, groupcast transmission, and unicast transmission.
   Example 4. The method according to any of examples 1-3, wherein the providing (504) is performed via a sidelink.
   Example 5. The method according to example 4, wherein the sidelink is performed via a PC5 interface.
   Example 6. The method according to example 2 and any of examples 3-5, wherein a first device (121) comprised in the one of the one or more devices (120) is a network node (130) and wherein the providing (504) is performed via a Uu interface.
   Example 7. The method according to any of examples 1-6, wherein the one or more criteria comprise one or more of:
a. a geographical location of the UAV,
b. a time periodicity,
c. an occurrence of an event, and
d. a request to provide the first indication received from a second device (122).

Example 8. The method according to example 7, wherein the method further comprises at least one of:
determining (501) that the one or more criteria have been met, wherein the one or more criteria comprise one or more of the geographical location of the UAV, the time periodicity, and the occurrence of the event, and wherein the providing (504) is triggered by a result of the determining (501), and
receiving (502) the request from the second device (122), and wherein the providing (504) is triggered by received request.
   Example 9. The method according to example 8, wherein, prior to providing (504) the first indication, the UAV (111) lacks an active connection with the second device (122), and wherein the UAV (111) receives the request from the second device (122) in a broadcasted message.
   Example 10. The method according to example 7 and any of examples 8-9, wherein, prior to providing (504) the first indication, the UAV (111) lacks an active connection with a third device (123), the third device (123) being the second device (122) or another network node, and wherein the method further comprises:
initiating (503) establishing an active connection with the third device (123), and wherein the providing (504) is performed a) with the initiation of the establishment of the active connection, or b) via the active connection once the active connection has been initiated.
   Example 11. The method according to example 7, wherein, prior to providing (504) the first indication, the UAV (111) maintains an active connection with the second device (122) and wherein the UAV (111) receives the request from the second device (122) in a Radio Resource Control message.
   Example 12. The method according to any of examples 1-11, wherein the first indication comprises at least one of:
i. an identifier of the UAV (111), e.g., a Drone ID, and
ii. a serial number of the UAV (111), e.g., Drone serial number, and
iii. a location of the UAV (111), e.g., Drone location.
   Example 13. A method, performed by device (120, 121, 122, 123) operating in a wireless communications network (100), the method comprising:
receiving (603), from an Unmanned Aerial Vehicle, UAV, (111), a first indication enabling identification of at least one aspect of the UAV (111), wherein the receiving (603) is performed with the proviso that one or more criteria are met.
   Example 14. The method according to example 13, wherein the receiving (603) is performed via one or more of: broadcast transmission, groupcast transmission, and unicast transmission.
   Example 15. The method according to any of examples 13-14, wherein the receiving (603) is performed via a sidelink.
   Example 16. The method according to example 15, wherein the sidelink is performed via a PC5 interface.
   Example 17. The method according to any of examples 13-14, wherein the device is a first device (121), wherein the first device (121) is a network node (130), and wherein the receiving (603) is performed via a Uu interface.
   Example 18. The method according to any of examples 13-17, wherein the one or more criteria comprise one or more of:
e. a geographical location of the UAV,
f. a time periodicity,
g. an occurrence of an event, and
h. a request to provide the first indication from the device (121) or a second device (122).
   Example 19. The method according to example 18, wherein the method further comprises at least one of:
sending (601) the request to the UAV (111), and wherein the receiving (603) is triggered by received request.
   Example 20. The method according to example 19, wherein, prior to receiving (603) the first indication, the device lacks an active connection with the UAV (111), and wherein the device (121) sends the request to the UAV (111) in a broadcasted message.
   Example 21. The method according to example 18 and any of examples 19-20, wherein, prior to receiving (603) the first indication, the device (121) lacks an active connection with the UAV (111), the device (121) being the second device (122) or another network node, and wherein the method further comprises:
initiating (602) establishing an active connection with the UAV (111) and wherein the receiving (603) is performed a) with the initiation of the establishment of the active connection, or b) via the active connection once the active connection has been initiated.
   Example 22. The method according to example 7, wherein, prior to receiving (603) the first indication, the device (121) maintains an active connection with the UAV (111) and wherein the device (121) sends the request to the UAV (111) in a Radio Resource Control message.
   Example 23. The method according to any of examples 13-22, wherein the first indication comprises at least one of:
i. an identifier of the UAV (111), e.g., a Drone ID, and
ii. a serial number of the UAV (111), e.g., Drone serial number, and
iii. a location of the UAV (111), e.g., Drone location.
   Example 24. A method, performed by a second device (122) operating in a wireless communications network (100), the method comprising:
sending (701) a request to an Unmanned Aerial Vehicle, UAV, (111) to provide a first indication enabling identification of at least one aspect of the UAV (111).
   Example 25. The method according to example 24, wherein the sending (701) is performed via one or more of: broadcast transmission, groupcast transmission, and unicast transmission.
   Example 26. The method according to any of examples 24-25, wherein the sending (701) is performed via a sidelink.
   Example 27. The method according to example 26, wherein the sidelink is performed via a PC5 30 interface.
   Example 28. The method according to any of examples any of examples 24-25, wherein the second device (122) is a network node (130), and wherein the sending (701) is performed via a Uu interface.
   Example 29. The method according to any of examples 24-28, wherein, the second device (122) lacks an active connection with the UAV (111), and wherein the second device (122) sends the request to the UAV (111) in a broadcasted message.
   Example 30. The method according to any of examples 24-29, wherein the second device (122) maintains an active connection with the UAV (111) and wherein the second device (122) sends the request to the UAV (111) in a Radio Resource Control message.

### Further Extensions and Variations

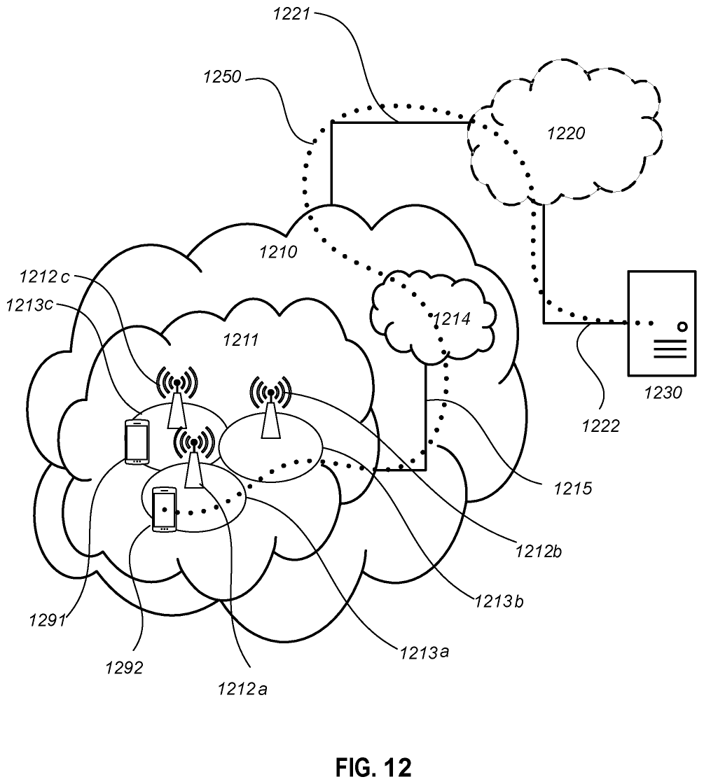

FIG. 12: Telecommunication Network Connected Via an Intermediate Network to a Host Computer in Accordance with Some Embodiments

With reference to FIG. 12, in accordance with an embodiment, a communication system includes telecommunication network 1210 such as the wireless communications network 100, for example, a 3GPP-type cellular network, which comprises access network 1211, such as a radio access network, and core network 1214. Access network 1211 comprises a plurality of network nodes such as the network node 130. For example, base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A plurality of user equipments, such as the wireless device 150 are comprised in the wireless communications network 100. In FIG. 12, a first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212. Any of the UEs 1291, 1292 are examples of the wireless device 150.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

In relation to FIGS. 13, 14, 15, 16, and 17, which are described next, it may be understood that a UE is an example of the wireless device 150, and that any description provided for the UE equally applies to the wireless device 150. It may be also understood that the base station is an example of the network node 130, and that any description provided for the base station equally applies to the network node 130.

FIG. 13: Host Computer Communicating Via a Base Station with a User Equipment Over a Partially Wireless Connection in Accordance with Some Embodiments

Example implementations, in accordance with an embodiment, of the wireless device 150, e.g., a UE, the network node 130, e.g., a base station and host computer discussed in the preceding paragraphs will now be described with reference to FIG. 13. In communication system 1300, such as the wireless communications network 100, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes the network node 130, exemplified in FIG. 13 as a base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with the wireless device 150, exemplified in FIG. 13 as a UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

The UAV 111 embodiments relate to FIG. 5, FIG. 9 and FIGS. 12-17.

The UAV 111 may comprise an interface unit to facilitate communications between the UAV 111 and other nodes or devices, e.g., the one or more devices 120, the first device 121, the second device 122, and/or the third device 123, the host computer 1310, or any of the other nodes. In some particular examples, the interface may, for example, include a transceiver configured to transmit and receive radio signals over an air interface in accordance with a suitable standard.

The UAV 111 may comprise an arrangement as shown in FIG. 9 or in FIG. 13.

The UAV 111 may also be configured to communicate user data with a host application unit in a host computer 1310, e.g., via another link such as 1360.

The device 120 embodiments relate to FIG. 6, FIG. 10 and FIGS. 12-17.

The device 120, 121, 122, 123 may comprise an interface unit to facilitate communications between the device 120, 121, 122, 123 and other nodes or devices, e.g., the UAV 111, other devices of the one or more devices 120, the network node 130, the host computer 1310, and/or any of the other nodes. In some particular examples, the interface may, for example, include a transceiver configured to transmit and receive radio signals over an air interface in accordance with a suitable standard.

The device 120, 121, 122, 123 may comprise an arrangement as shown in FIG. 10 or in FIG. 13.

The device 120, 121, 122, 123 may also be configured to communicate user data with a host application unit in a host computer 1310, e.g., via another link such as 1360.

The second device 122 embodiments relate to FIG. 7, FIG. 11 and FIGS. 12-17.

The second device 122 may comprise an interface unit to facilitate communications between the second device 122 and other nodes or devices, e.g., the UAV 111, other devices of the one or more devices 120, the network node 130, the host computer 1310, and/or any of the other nodes. In some particular examples, the interface may, for example, include a transceiver configured to transmit and receive radio signals over an air interface in accordance with a suitable standard.

The second device 122 may comprise an arrangement as shown in FIG. 11 or in FIG. 13.

The second device 122 may also be configured to communicate user data with the UAV 111, and/or other devices of the one or more devices 120, the network node 130, a host application unit in a host computer 1310, e.g., via another link such as 1360.

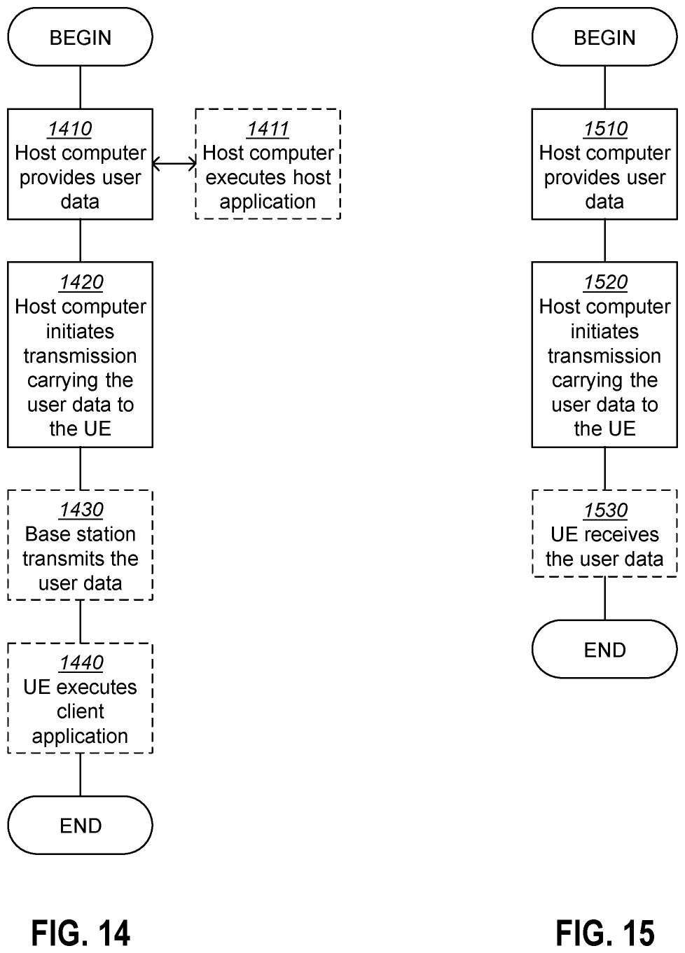

FIG. 14: Methods Implemented in a Communication System Including a Host Computer, a Base Station and a User Equipment in Accordance with Some Embodiments

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

FIG. 15: Methods Implemented in a Communication System Including a Host Computer, a Base Station and a User Equipment in Accordance with Some Embodiments

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

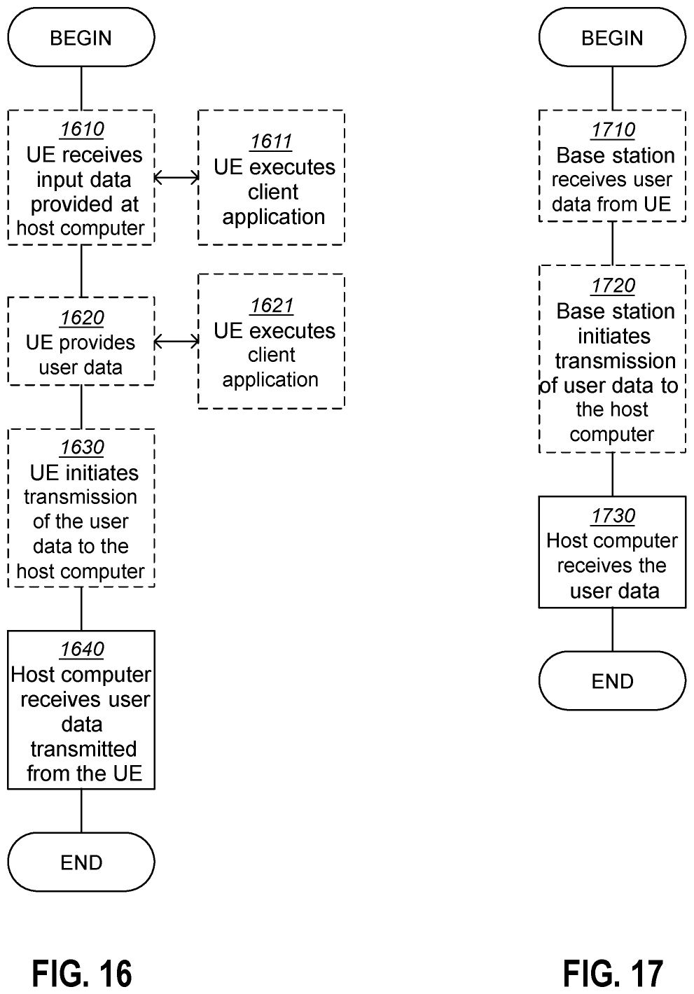

FIG. 16: Methods Implemented in a Communication System Including a Host Computer, a Base Station and a User Equipment in Accordance with Some Embodiments

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

FIG. 17: Methods Implemented in a Communication System Including a Host Computer, a Base Station and a User Equipment in Accordance with Some Embodiments

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 130.
5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the network node 130.
   6. The communication system of embodiment 5, further including the base station.
   7. The communication system of embodiment 6, further including the UE, wherein the UE is configured to communicate with the base station.
   8. The communication system of embodiment 7, wherein:
the processing circuitry of the host computer is configured to execute a host application, thereby providing the user data; and
the UE comprises processing circuitry configured to execute a client application associated with the host application.
   11. A method implemented in a base station, comprising one or more of the actions described herein as performed by the network node 130.
   15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the network node 130.
   16. The method of embodiment 15, further comprising:
at the base station, transmitting the user data.
   17. The method of embodiment 16, wherein the user data is provided at the host computer by executing a host application, the method further comprising:
at the UE, executing a client application associated with the host application.
   21. A user equipment (UE) configured to communicate with a base station, the UE comprising a radio interface and processing circuitry configured to perform one or more of the actions described herein as performed by the wireless device 150.
   25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the wireless device 150.
   26. The communication system of embodiment 25, further including the UE.
   27. The communication system of embodiment 26, wherein the cellular network further includes a base station configured to communicate with the UE.
   28. The communication system of embodiment 26 or 27, wherein:
the processing circuitry of the host computer is configured to execute a host application, thereby providing the user data; and
the UE's processing circuitry is configured to execute a client application associated with the host application.
   31. A method implemented in a user equipment (UE), comprising one or more of the actions described herein as performed by the wireless device 150.
   35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the wireless device 150.
   36. The method of embodiment 35, further comprising:
at the UE, receiving the user data from the base station.
   41. A user equipment (UE) configured to communicate with a base station, the UE comprising a radio interface and processing circuitry configured to perform one or more of the actions described herein as performed by the wireless device 150.
   45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the wireless device 150.
   46. The communication system of embodiment 45, further including the UE.
   47. The communication system of embodiment 46, further including the base station, wherein the base station comprises a radio interface configured to communicate with the UE and a communication interface configured to forward to the host computer the user data carried by a transmission from the UE to the base station.
   48. The communication system of embodiment 46 or 47, wherein:
the processing circuitry of the host computer is configured to execute a host application; and
the UE's processing circuitry is configured to execute a client application associated with the host application, thereby providing the user data.
   49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.
   51. A method implemented in a user equipment (UE), comprising one or more of the actions described herein as performed by the wireless device 150.
   52. The method of embodiment 51, further comprising:
providing user data; and
forwarding the user data to a host computer via the transmission to the base station.
   55. A method implemented in a communication system including a host computer, a base station and a user equipment (UE), the method comprising:
at the host computer, receiving user data transmitted to the base station from the UE, wherein the UE performs one or more of the actions described herein as performed by the wireless device 150.
   56. The method of embodiment 55, further comprising:
at the UE, providing the user data to the base station.
   57. The method of embodiment 56, further comprising:
at the UE, executing a client application, thereby providing the user data to be transmitted; and
at the host computer, executing a host application associated with the client application.
   58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.
   61. A base station configured to communicate with a user equipment (UE), the base station comprising a radio interface and processing circuitry configured to perform one or more of the actions described herein as performed by the network node 130.
   65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 130.
   66. The communication system of embodiment 65, further including the base station.
   67. The communication system of embodiment 66, further including the UE, wherein the UE is configured to communicate with the base station.
   68. The communication system of embodiment 67, wherein:
the processing circuitry of the host computer is configured to execute a host application;
the UE is configured to execute a client application associated with the host application, thereby providing the user data to be received by the host computer.
   71. A method implemented in a base station, comprising one or more of the actions described herein as performed by the network node 130.
   75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the wireless device 150.
   76. The method of embodiment 75, further comprising:
at the base station, receiving the user data from the UE.
   77. The method of embodiment 76, further comprising:
at the base station, initiating a transmission of the received user data to the host computer.

1.-63. (canceled)

64. A method performed by an Unmanned Aerial Vehicle (UAV) operating in a wireless communication network, the method comprising:
determining whether one or more criteria have been met; and
in response to determining that the one or more criteria have been met, transmitting to one or more devices operating in the wireless communication network a first indication enabling identification of at least one aspect of the UAV.

65. The method according to claim 64, wherein the first indication is transmitted via one or more of the following: broadcast, groupcast, and unicast.

66. The method according to claim 64, wherein transmitting the first indication is performed by sidelink transmission via a PC5 interface.

67. The method according to claim 64, wherein the first indication is transmitted to a network node via a Uu interface.

68. The method according to claim 64, wherein the one or more criteria comprise one or more of the following:
the UAV entering a particular geographical location or reaching particular geographical coordinates,
a time for periodic reporting,
an occurrence of an event that triggers reporting, and
a request to provide the first indication, received from a second device operating in the wireless communication network.

69. The method according to claim 68, further comprising receiving the request from the second device, and wherein transmitting the first indication is responsive to the request.

70. The method according to claim 69, wherein:
the UAV lacks an active connection with the second device before transmitting the first indication; and
the request is received from the second device in a broadcast message.

71. The method according to claim 68, wherein:
before providing the first indication, the UAV lacks an active connection with a third device, which is the second device or a network node;
the method further comprises, in response to determining that the one or more criteria have been met, initiating establishment of an active connection with the third device; and
the first indication is transmitted according to one of the following: during establishment of the active connection, or via the active connection after it has been established.

72. The method according to claim 69, wherein:
the UAV has an active connection with the second device before transmitting the first indication; and
the request from the second device is received in a Radio Resource Control message via the active connection.

73. The method according to claim 64, wherein the first indication comprises at least one of the following: an identifier of the UAV, a serial number of the UAV, and a location of the UAV.

74. The method according to claim 64, further comprising refraining from transmitting the first indication in response to determining that the one or more criteria have not been met.

75. A method performed by device operating in a wireless communication network, the method comprising:
receiving, from an Unmanned Aerial Vehicle (UAV), a first indication enabling identification of at least one aspect of the UAV, wherein the indication is responsive to a determination by the UAV that one or more criteria have been met.

76. The method according to claim 75, wherein the first indication is received as one or more of the following: a broadcast transmission, a groupcast transmission, and a unicast transmission.

77. The method according to claim 75, wherein the first indication is received as a sidelink transmission via a PC5 interface.

78. The method according to claim 75, wherein the device is a network node and the first indication is received via a Uu interface.

79. The method according to claim 75, wherein the one or more criteria comprise one or more of the following:
the UAV entering a particular geographical location or reaching particular geographical coordinates,
a time for periodic reporting,
an occurrence of an event that triggers reporting, and
a request for the UAV to provide the first indication, by the device or by a second device operating in the wireless communication network.

80. The method according to claim 75, wherein the first indication comprises at least one of the following: an identifier of the UAV, a serial number of the UAV, and a location of the UAV.

81. An Unmanned Aerial Vehicle (UAV) configured to operate in a wireless communication network, the UAV comprising:
radio circuitry configured to communicate with one or more other devices configured to operate in the wireless communication network; and
processing circuitry operably coupled to the radio circuitry, whereby the processing circuitry and the radio circuitry are configured to:
determine that one or more criteria have been met; and
in response to determining that the one or more criteria have been met, transmit to one or more devices operating in the wireless communication network a first indication enabling identification of at least one aspect of the UAV.

82. The UAV according to claim 81, wherein the one or more criteria comprise one or more of the following:
the UAV entering a particular geographical location or reaching particular geographical coordinates,
a time for periodic reporting,
an occurrence of an event that triggers reporting, and
a request to provide the first indication, received from a second device operating in the wireless communication network.

83. The UAV according to claim 81, wherein the first indication comprises at least one of the following: an identifier of the UAV, a serial number of the UAV, and a location of the UAV.

84. A device configured to operate in a wireless communication network, the device comprising:
radio circuitry configured to communicate with one or more other devices configured to operate in the wireless communication network; and
processing circuitry operably coupled to the radio circuitry, whereby the processing circuitry and the radio circuitry are configured to perform operations corresponding to the method of claim 75.
